(19) United States
(12) Patent Application Publication
(10) Pub. No.: US 2025/0062502 A1
(43) Pub. Date: Feb. 20, 2025

(54) COIN CELL BATTERIES INCLUDING TITANIUM-BASED CONTACT MATERIALS WITH IMPROVED COLD FORMABILITY FOR SAFER COIN CELL BATTERIES

(71) Applicant: Energizer Brands, LLC, St. Louis, MO (US)

(72) Inventors: Weiwei Huang, St.Louis, MO (US); Jingdong Guo, St.Louis, MO (US)

(21) Appl. No.: 18/235,125

(22) Filed: Aug. 17, 2023

(51) Int. Cl. H01M 50/534; H01M 10/04; H01M 50/109; H01M 50/167; H01M 50/533

(52) U.S. Cl. CPC H01M 50/534; H01M 10/0427; H01M 10/049; H01M 50/109; H01M 50/167; H01M 50/533

(57) ABSTRACT

Described are safer coin cells and materials having improved cold formability for making a contact for the coin cell. A titanium-based material can be used that has ≥95 wt. % titanium, ≤0.5 wt. % iron, ≤0.5 wt. % oxygen, ≤0.5 wt. % carbon, ≤0.5 wt. % nitrogen, and ≤0.5 wt. % hydrogen. A contact made from such material is resistant to reactions that form hydroxides in contact with bodily fluids, such as after ingestion. The titanium-based material has improved cold formability at room temperature, which reduces or eliminates microcracking during formation of the contact. Reduced or eliminated microcracking reduced or eliminated alkalizing reactions that would otherwise occur with conventional coin cells when in contact with bodily fluids.

### FIELD

The present disclosure relates to coin cells, and specifically, to materials and coatings for cans, terminals, and contacts for coin cells, and more specifically to materials and coatings for positive cans, terminals, and contacts for coin cells that reduce or eliminate hydroxide generation when the coin cell is in contact with bodily fluids, and even more specifically to materials that exhibit improved cold formability so as to avoid microcracking of the material during formation therefrom of a positive can, terminal, or contact for a coin cell.

### BACKGROUND

Coin cells or coin cell batteries (also referred to as button cells or button cell batteries), such as those described in International Patent Publication No. PCT/US2013/021430, filed Jan. 14, 2013, the contents of which are incorporated herein by reference in their entirety, are small, disc-shaped batteries commonly used in a wide range of electronic devices, such as hearing aids, cochlear implant processors, calculators, remote controls, and wristwatches, etc. These cells and batteries are often referred to as coin cells due to their shape and size.

Accidental ingestion of coin cells by children can lead to acute injury and even death, in part due to an electrical current from the battery generating hydroxide (high pH) on the negative side through an electrolysis reaction that occurs when the battery is in contact with bodily fluids, such as tissue fluids, mucus, esophageal lining fluids, stomach fluids, or the like. The hydroxide formed causes alkaline burns and perforations of the esophagus. Severe injuries can occur in as little as two hours.

To address this issue, certain coin cells have been contemplated that incorporate one or more anti-swallow features. For example, an anti-swallow feature is a raised border around the circumference of the battery. The raised border makes it difficult for a child to swallow the battery. Other anti-swallow features encompass a bitter-tasting coating on the surface of the battery that deters children from putting the battery in their mouths. However, if swallowed, a coin cell or button cell coated with a bitterant or having a raised circumferential border will still cause an electrolysis reaction in the esophagus or stomach and cause severe injury.

### BRIEF SUMMARY

Various embodiments are directed to coin cells and coin cell batteries, and in particular to coin cell batteries including contact materials with improved cold formability for safer coin cell batteries.

Described are titanium-based strips with improved cold formability as the positive can for safer coin cells/batteries. Coin cell positive cans may be made from a titanium-based strip having ≥95 wt. % titanium, ≤0.5 wt. % iron, ≤0.5 wt. % oxygen, ≤0.5 wt. % carbon, ≤0.5 wt. % nitrogen, and ≤0.5 wt. % hydrogen. The contact is resistant to alkalizing or electrolytic reactions that occur when the coin cell is ingested and contacts certain bodily fluids. The titanium-based strip has improved mechanical properties, such as improved cold formability. When a bend is formed in the titanium-based strip having a bend radius of between about 100% to about 500% of the thickness, for example a bend radius equal to or less than about 150% the thickness of the titanium-based strip during formation of the positive can, reduced or no microcracking of the titanium-based strip material occurs. The reduced or eliminated microcracking reduces or eliminates the incidence of alkalizing or electrolytic reactions that would otherwise occur with conventional coin cells that use positive can materials that exhibit microcracking during formation of the positive can.

According to an embodiment, a casing is provided, the casing being configured for use in an electrochemical coin cell, the casing comprising: a housing having a flat wall and a side wall extending from one or more edges of the flat wall of the housing to form a housing can; and a planar conductive portion joined to the side wall of the housing to form an inner cavity configured to hold active components of the electrochemical coin cell, wherein the housing or the planar conductive portion comprises greater than about 95 wt. % titanium, and wherein a bend radius between the flat wall and the side wall of the housing is less than or equal to about 150% of the thickness of the housing metal or the planar conductive portion. As described in other portions of this disclosure, a bend radius can be measured using, e.g., ASTM Test Method E290, “Test Methods for Bend Testing of Materials for Ductility.” The term “bend radius” is used herein to describe a bend radius, a minimum bend radius, a maximum bend radius, or an average bend radius of a material/strip, such as a titanium-based strip, when formed into a can, terminal, or other portion of a coin cell, and “bend radius” is also used herein to describe a bend radius, a minimum bend radius, a maximum bend radius, or an average bend radius that can be exerted upon a material/strip, such as a titanium-based strip, without the material/strip forming any or substantially any microcracking or other bend-related damage at or near the bend, e.g., as measured according to ASTM Test Method E290.

In some embodiments, the housing or the planar conductive portion comprises greater than about 99 wt. % titanium. In some embodiments, the housing or the planar conductive portion comprises less than about 0.5 wt. % iron, less than about 0.5 wt. % oxygen, less than about 0.5 wt. % carbon, less than about 0.5 wt. % nitrogen, and less than about 0.5 wt. % hydrogen. In some embodiments, the housing or the planar conductive portion comprises about 0.3 wt. % iron, about 0.25 wt. % oxygen, about 0.1 wt. % carbon, about 0.03 wt. % nitrogen, and about 0.015 wt. % hydrogen. In some embodiments, the housing or the planar conductive portion has an ultimate tensile strength of between about 35,000 psi and about 60,000 psi. In some embodiments, the housing or the planar conductive portion has a breaking elongation of between about 10% and about 50%. In some embodiments, the housing or the planar conductive portion has an elastic modulus of between about 10,000 ksi and about 20,000 ksi. In some embodiments, the housing or the planar conductive portion has a compressive modulus of between about 10,000 ksi and about 20,000 ksi. In some embodiments, the housing or the planar conductive portion has a shear modulus of between about 4,000 ksi and about 10,000 ksi. In some embodiments, the housing or the planar conductive portion has a Poisson's ratio of between about 0.25 and about 0.40. In some embodiments, the housing or the planar conductive portion has an annealed fracture toughness of between about 50 ksi-in^{1/2} and about 65 ksi-in^{1/2}. In some embodiments, the housing or the planar conductive portion has an elongation of greater than about 20% (e.g., between about 20% and about 50%) at room temperature (e.g., about 21° C.). In some embodiments, the housing or the planar conductive portion has an electrical resistivity of between about 40 μΩ·cm and about 100μΩ·cm.

In some embodiments, an exterior circumferential portion of the planar conductive portion is bent between about 90 degrees and about 270 degrees out of plane with a remainder of the planar conductive portion when being joined with the side wall of the housing. In some embodiments, one or more of the housing or the planar conductive portion comprises a surface portion comprising one or more of: TIN, Ti₂N, or TiC. In some embodiments, one or more of the housing or the planar conductive portion comprises a surface coating comprising nickel. In some embodiments, the housing or the planar conductive portion comprises a material that is resistant to reactions that cause hydroxide formation.

According to another embodiment, an electrochemical coin cell can be provided that comprises: a cylindrical casing comprising a positive contact surface and a side wall formed circumferentially about the positive contact surface, wherein the cylindrical casing defines an inner volume; an anode material disposed within a first portion of the inner volume; a cathode material disposed within a second portion of the inner volume; a separator disposed within the inner volume between the anode material and the cathode material; an electrolyte material disposed within the inner volume and configured to communicate ions between the anode material and the cathode material; and a negative contact surface, the negative contact surface being disposed within or adjacent to the inner volume such that the anode material, the cathode material, the separator, and the electrolyte material are enclosed within the inner volume, wherein a portion of the side wall is joined to an edge of the planar negative contact surface to seal the inner volume of the cylindrical casing. In some embodiments, a thickness of the negative contact surface is between about 0.1 mm and about 0.5 mm.

In some embodiments, the titanium-containing material comprises greater than about 95 wt. % titanium. In some embodiments, the titanium-containing material comprises greater than about 99 wt. % titanium. In some embodiments, the titanium-containing material comprises less than about 0.5 wt. % iron, less than about 0.5 wt. % oxygen, less than about 0.5 wt. % carbon, less than about 0.5 wt. % nitrogen, and less than about 0.5 wt. % hydrogen. In some embodiments, the titanium-containing material comprises about 0.3 wt. % iron, about 0.25 wt. % oxygen, about 0.1 wt. % carbon, about 0.03 wt. % nitrogen, and about 0.015 wt. % hydrogen.

In some embodiments, the titanium-containing material has an ultimate tensile strength of between about 40,000 psi and about 60,000 psi. In some embodiments, the titanium-containing material has a breaking elongation of between about 10% and about 50%. In some embodiments, the titanium-containing material has an elastic modulus of between about 10,000 ksi and about 20,000 ksi. In some embodiments, the titanium-containing material has a compressive modulus of between about 10,000 ksi and about 20,000 ksi. In some embodiments, the titanium-containing material has a shear modulus of between about 4,000 ksi and about 10,000 ksi. In some embodiments, the titanium-containing material has a Poisson's ratio of between about 0.25 and about 0.40. In some embodiments, the titanium-containing material has an annealed fracture toughness of between about 50 ksi-in^{1/2} and about 65 ksi-in^{1/2}. In some embodiments, the titanium-containing material has an electrical resistivity of between about 40μΩ·cm and about 100μΩ·cm.

In some embodiments, the negative contact surface comprises stainless steel. In some embodiments, the negative contact surface comprises a metal-clad stainless steel material.

In some embodiments, after bending of the edge of the planar negative contact surface and joining of the negative contact surface to the portion of the side wall of the cylindrical casing to seal the electrochemical coin cell, when an outside surface of the planar negative contact surface of the electrochemical coin cell is exposed to human bodily fluids, substantially no hydroxides are formed during the subsequent period, e.g., 480 minutes.

According to another embodiment, an electrochemical coin cell can be provided that comprises: active electrochemical components comprising an anode, a separator, and a cathode, wherein the active electrochemical components produce an output open circuit voltage of at least 2.8 volts in the presence of a non-aqueous electrolyte; and a cylindrical container enclosing the active components, the cylindrical container comprising an anode terminal casing and a cathode terminal casing with an electrically insulating gasket disposed of therebetween, the anode terminal casing being in electrical communication with the anode and the cathode terminal casing being in electrical communication with the cathode. In some embodiments, the cathode terminal casing consists of a first material that is resistant to reactions producing hydroxides during exposure to human bodily fluids. In some embodiments, the anode terminal casing consists of a second material different from the first material. In some embodiments, the first material comprises greater than about 99 wt. % titanium. In some embodiments, a circumferential edge portion of the anode terminal casing is bent or crimped to join the cathode terminal casing to the cylindrical container. In some embodiments, a circumferential edge portion of the cathode terminal casing is bent or crimped to join the anode terminal casing to the cylindrical container.

In some embodiments, the first material has a composition that is different from the composition of the second material. In some embodiments, the second material comprises stainless steel. In some embodiments, the first material comprises less than about 0.5 wt. % iron, less than about 0.5 wt. % oxygen, less than about 0.5 wt. % carbon, less than about 0.5 wt. % nitrogen, and less than about 0.5 wt. % hydrogen. In some embodiments, the first material comprises about 0.3 wt. % iron, about 0.25 wt. % oxygen, about 0.1 wt. % carbon, about 0.03 wt. % nitrogen, and about 0.015 wt. % hydrogen.

In some embodiments, the first material has an ultimate tensile strength of between about 40,000 psi and about 60,000 psi. In some embodiments, the first material has a breaking elongation of between about 10% and about 50%. In some embodiments, the first material has an elastic modulus of between about 10,000 ksi and about 20,000 ksi. In some embodiments, the first material has a compressive modulus of between about 10,000 ksi and about 20,000 ksi. In some embodiments, the first material has a shear modulus of between about 4,000 ksi and about 10,000 ksi. In some embodiments, the first material has a Poisson's ratio of between about 0.25 and about 0.40. In some embodiments, the first material has an annealed fracture toughness of between about 50 ksi-in^{1/2} and about 65 ksi-in^{1/2}. In some embodiments, the first material has an electrical resistivity of between about 40 μΩ·cm and about 100 μΩ·cm.

According to another embodiment, a method for manufacturing or forming a casing for an electrochemical coin cell can be carried out. In some embodiments, the method comprises: forming a first contact surface for the electrochemical coin cell from a first sheet consisting of a first material, the first material comprising greater than about 99 wt. % titanium; forming a cylindrical housing cup from a second sheet consisting of a second material, the cylindrical housing cup comprising a substantially flat bottom and a side wall formed circumferentially about the substantially flat bottom, the substantially flat bottom forming a second contact surface for the electrochemical coin cell, the substantially flat bottom and the side wall forming an inner volume; disposing active electrochemical components into the inner volume of the cylindrical housing cup, the active electrochemical components comprising an anode, a separator and a cathode, wherein the active electrochemical components are configured to produce an output open circuit voltage of at least 2.8 volts in the presence of a non-aqueous electrolyte; and sealing the active electrochemical components within the inner volume of the electrochemical coin cell by joining a circumferential edge of the first contact surface to one or more portions of the side wall of the cylindrical housing cup such that the first and second contact surfaces are in electrical communication with the active electrochemical components. In some embodiments, the circumferential edge of the first contact surface is joined to one or more portions of the side wall of the cylindrical housing cup by bending or crimping one or more of the circumferential edge of the first contact surface or the one or more portions of the side wall of the cylindrical housing cup.

In some embodiments, the first contact surface consisting of the first material is dimensioned and configured to be resistant to reactions producing hydroxides during exposure to human bodily fluids. In some embodiments, the first material is different from the second material. In some embodiments, the second material comprises stainless steel. In some embodiments, the first material comprises less than about 0.5 wt. % iron, less than about 0.5 wt. % oxygen, less than about 0.5 wt. % carbon, less than about 0.5 wt. % nitrogen, and less than about 0.5 wt. % hydrogen. In some embodiments, the first material comprises about 0.3 wt. % iron, about 0.25 wt. % oxygen, about 0.1 wt. % carbon, about 0.03 wt. % nitrogen, and about 0.015 wt. % hydrogen.

In some embodiments, the first material has an ultimate tensile strength of between about 40,000 psi and about 60,000 psi. In some embodiments, the first material has a breaking elongation of between about 10% and about 50%. In some embodiments, the first material has an clastic modulus of between about 10,000 ksi and about 20,000 ksi. In some embodiments, the first material has a compressive modulus of between about 10,000 ksi and about 20,000 ksi. In some embodiments, the first material has a shear modulus of between about 4,000 ksi and about 10,000 ksi. In some embodiments, the first material has a Poisson's ratio of between about 0.25 and about 0.40. In some embodiments, the first material has an annealed fracture toughness of between about 50 ksi-in^{1/2} and about 65 ksi-in^{1/2}. In some embodiments, the first material has an electrical resistivity of between about 40 μΩ·cm and about 100 μΩ·cm.

In some embodiments, the method can further comprise: coating a portion or all of the first material or the first contact surface with a nickel-containing surface coating.

### BRIEF DESCRIPTION OF THE DRAWINGS

Reference will now be made to the accompanying drawings, which are not necessarily drawn to scale. The accompanying appendices, drawings, figures, images, etc. illustrate various example, non-limiting, inventive aspects, embodiments, and features (“e.g.,” or “example(s)”) in accordance with the present disclosure:

FIG. 1 is a schematic of a coin cell, according to an embodiment, submersed in a saliva solution;

FIG. 2 is a perspective and cross-sectional view of an electrochemical coin cell, according to an embodiment;

FIG. 3 is a two-dimensional cross-sectional view of the electrochemical coin cell as illustrated in FIG. 2;

FIG. 4 illustrates an example of a metal-based strip having a bend formed therein for a terminal of a coin cell battery, according to embodiments described herein;

FIG. 5 is an image of a titanium-clad stainless steel terminal for a coin cell battery showing cracks due to bending during manufacturing of a coin cell battery, according to an embodiment described herein;

FIG. 6 illustrates a titanium-based strip for forming a terminal for a coin cell battery, according to embodiments described herein;

FIG. 7 is a graph illustrating impedance data for coin cell batteries described herein, according to embodiments described herein;

FIG. 8 is a flow diagram of a method, according to an embodiment described herein;

FIG. 9 is a flow diagram of a method, according to an embodiment described herein;

FIG. 10 is a flow diagram of a method, according to an embodiment described herein; and

FIG. 11 is a flow diagram of a method, according to an embodiment described herein.

### DETAILED DESCRIPTION

Coin cell batteries, also known as button cells, are small, single-cell batteries that are typically used to power low-power devices such as watches, calculators, hearing aids, and small electronic devices. These batteries are small and compact, making them easy to use and store, and are available in a wide variety of sizes, chemistries, and voltage ratings.

Coin cell batteries were initially developed for use in hearing aids and are now used in a variety of other applications and devices, such as watches, calculators, and other small electronic devices. Coin cell batteries typically consist of a positive electrode (cathode), a negative electrode (anode), and an electrolyte that allows the flow of ions between the electrodes. The electrodes and electrolyte are enclosed in a small, circular metal casing that is typically made from stainless steel or nickel-plated brass.

The positive electrode is typically made from a metal oxide, such as silver oxide or manganese dioxide, and is coated onto a metal grid or foil. The negative electrode is typically made from a metal such as zinc or lithium and is also coated onto a metal grid or foil. The electrolyte is typically a liquid or gel and is designed to allow the flow of ions between the electrodes.

The electrodes and electrolyte are arranged in a specific configuration within the metal casing, depending on the battery chemistry and voltage rating. For example, in a silver oxide-based battery, the positive electrode is placed in the center of the battery, while the negative electrode is placed around the outside of the positive electrode. This arrangement allows the battery to deliver a high voltage output while maintaining a small size.

External components include a shell or housing defining an inner volume in which the anode and cathode are housed, kept physically apart by a separator, such as an ion-permeable separator, an electrolyte-permeable separator, or the like. The anode and cathode have different active materials, such as zinc and manganese dioxide, respectively. These materials are selected for their electrochemical properties that allow them to facilitate the flow of electrons from one terminal to the other. The electrolyte is a liquid or gel substance that allows for the movement of ions between the anode and cathode. The electrolyte is often a combination of a salt, such as potassium hydroxide, and water.

Coin cell batteries are available in a wide variety of chemistries, each with its own unique performance characteristics. For example, alkaline coin cell batteries are the most common type of coin cell battery and are typically used in low-power devices such as watches, calculators, and small electronic devices. These batteries use an alkaline electrolyte and a zinc-based negative electrode and are available in a wide variety of sizes and voltage ratings. Silver oxide coin cell batteries are typically used in high-power devices such as cameras, calculators, and medical equipment. These batteries use a silver oxide positive electrode and a zinc-based negative electrode and are designed to deliver a high voltage output and long life. Zinc-air coin cell batteries are typically used in hearing aids and use a zinc-based negative electrode and air as the positive electrode. However, these battery chemistries often have drawbacks such as off-gassing risk, explosion risk, fire risk, reduced battery life, inconsistent discharge, discharge temperature change issues, and others. Lithium is a popular alternative to other conventional battery chemistries, especially for use in low-power devices such as watches, calculators, and small electronic devices that use coin cell batteries. These batteries typically use a lithium-based positive electrode and a carbon-based negative electrode.

However, accidental ingestion of coin cells by children can lead to severe injury and even death, in large part due to an electrical current from the battery generating hydroxide (high pH) on the negative terminal or contact. The electrical current at the negative terminal or contact can cause an alkalizing reaction and/or electrolysis reaction when the negative terminal or contact of the battery is in contact with bodily fluids, such as saliva, tissue fluids, mucus, esophageal lining fluids, stomach fluids, or the like. Hydroxides formed during the analyzing/electrolysis reactions cause alkaline burns and perforations of the mouth, esophagus, stomach lining, and/or intestines. Severe injuries can occur in as little as two hours after ingestion.

To address the dangers inherent in the small size of coin-cell batteries, manufacturers have implemented anti-swallow features. One common anti-swallow feature is a raised border around the circumference of the coin cell battery. This border makes it more difficult for a child to swallow the battery, but may only help reduce ingestion by infants, whereas toddlers can still ingest coin cell batteries having a raised border about the circumference of the coin cell battery. Certain coin cells are coated with one or more bitterants, which are bitter-tasting substances, to deter children from putting the coin cell in their mouths. However, not all infants, toddlers, or even older children are dissuaded from putting a coin cell battery coated with a bitterant in their mouth. If swallowed, a coin cell, whether coated with a bitterant or having a raised circumferential border, or otherwise modified to dissuade or prevent swallowing behaviorally, will still cause an electrolysis reaction in the child's mouth, esophagus, stomach, or intestines, and will still cause severe injury or death. Furthermore, coin cells present risks to human health in other scenarios also, even when not ingested, such as if a child inserts a coin cell battery into their nose, car, or other body cavity. For example, when inserted into the nose, a coin cell can cause mucosal injuries, nasal septal perforations, nasal adhesions, and saddle nose deformity. As such, anti-swallow techniques oftentimes used, such as bitterant coatings, will not be effective for preventing other dangerous exposures of children to alkalizing reactions that can occur when a child lodges a coin cell in their nose, car, or other body cavity.

Described herein are coin cell batteries that comprise terminal materials (e.g., positive terminal materials) that are resistant to such alkalizing/electrolysis reactions. One option is to use a material for the positive terminal that is resistant to electrolysis reaction, since discharge-related electrolysis often originates at the positive terminal. Positive terminal materials contemplated include but are not limited to: titanium, titanium alloys, titanium nitride, tantalum, niobium, gold, and boron-doped diamond materials. In some embodiments and for certain applications, titanium, titanium alloys, and/or titanium nitride may be preferred material choices for the positive terminal due to application-specific improved effectiveness for mitigating electrolysis reactions. In other embodiments, the negative terminal and/or battery casing can be made from one or more materials that is resistant to alkalizing/electrolysis reactions alternatively to, or in addition to, the positive terminal.

Rather than focusing on corrosion reactions, and particularly those believed to occur in the acidic environment of the stomach (as disclosed in the prior art), the inventors discovered the harm caused by ingested coin batteries occurred as a result of cells becoming lodged in the esophagus, where it may sustain prolonged exposure to saliva. To the extent that saliva is effectively a neutral aqueous solution comprised primarily of water, it may be necessary to mitigate the effects of electrolysis of saliva occurring when the terminals of the lodged battery create a voltage, as will be described in greater detail below. The inventors further determined that the phenomenon is particularly acute with relatively large coin battery sizes (i.e., those having a total cell external diameter of about 5 mm to about 25 mm and a total cell height of about 0.5 mm to about 10 mm; e.g., CR2016, CR2032, etc.) and/or in children or other persons who have an esophagus of comparatively small diameter.

The principal electrochemical reaction that occurs upon ingestion of a coin cell battery is electrolysis of water because the following factors are present: (a) the coin cell itself supplies a DC voltage, ˜3V OCV (open circuit voltage); (b) an ionic conductive media (saliva) connects the anode (+) and cathode (−) terminal; and (c) the two terminals and saliva conducting path complete a closed circuit for an electrolysis cell. If the voltage supply of the electrolysis cell is high enough to overcome the polarization and the 1.23V thermodynamic voltage window for water electrolysis, electrochemical reactions will occur. Indeed, the electrolysis reaction associated with the ingestion of lithium cells is likely more severe than the electrolysis associated with ingestion of alkaline cells. This is because the driving force (the difference in voltage between the cell voltage and theoretical water electrolysis voltage, 1.23 V) is much higher in the case of a 3V lithium cell than in the case of a 1.5V alkaline cell (3.0V−1.23V=1.77V in the case of a lithium cell vs. 1.5V−1.23V=0.27V in the case of an alkaline cell).

Significantly, the nomenclature for an electrolysis cell is the opposite of that used for a battery. Accordingly, the terms “anode” and “electrolysis anode” refer to the electrode subject to an oxidation reaction and the terms “cathode” and “electrolysis cathode” refer to the electrode subject to the reduction reaction. When an electrolysis cell, such as a coin cell, is assembled and active electrochemical components are sealed within the cell, the negative terminal will be in electrical communication with the anode or electrolysis anode, while the positive terminal will be in electrical communication with the cathode or electrolysis cathode. Also, it should be noted that electrolysis requires application of voltage and, as such, provides a direct contrast to corrosion which typically occurs naturally under ambient conditions.

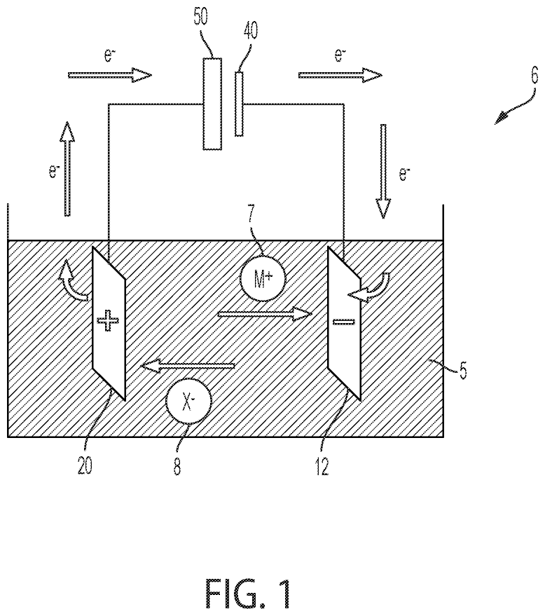

FIG. 1 helps illustrate the electrolysis reaction at issue. A simulated Li—MnO₂ electrochemical coin cell 6 submerged in saliva solution 5. The principal reactions that occur when a cell having these same components is accidentally ingested and lodged in the esophagus of a human are shown, although the cell electrodes are shown as discrete parts. Specifically, cell 6 operates at approximately 3V DC and includes coin cell cup (e.g., the positive electrode container) 12, coin cell can (e.g., the negative electrode container) 20, anode 40 and cathode 50. The anode 40 and cathode 50 comprise materials specifically selected for their compatibility with an intended electrochemical reaction; for example, x Li+MnO₂→Li\hat{ }MnO₂, in which the Mn undergoes a reduction as the lithium ion enters into the crystal lattice.

The external surface of the coin cell cup 12 acts as the negative terminal (cathode in an electrolysis cell) and the external surface of the coin cell can 20 acts as the positive terminal (anode in an electrolysis cell). A hydrogen gas evolution reaction takes place on coin cell cup 12 by accepting electrons from battery anode 40, which in this case includes lithium. At the coin cell can 20 (anode in an electrolysis cell), multiple reactions such as metallic dissolution, oxygen gas evolution, and possibly chloride oxidation occur and compete with one another. Charge neutrality in saliva solution 5 is preserved by the movement of anions 8 from the cell cup 12 (negative terminal) toward coin cell can 20 (positive terminal) and by the movement of cations 7 in the opposite direction. As metal from coin cell can 20 oxidizes, it loses electrons to battery cathode 50, which is manganese dioxide in this case. Ultimately, the final product at the coin cell can 20 depends on its potential and the solution pH is a consequence of the combined anode and cathode reactions. Further, the solution pH reflects real time product generated in the reaction zone between the esophagus and coin cell; therefore, the solution pH is localized and not necessarily reflective of the pH of the bulk solution (i.e., the remainder of the saliva which is not proximate to the reaction zone).

Possible electrochemical reactions on the coin cell cup 12 (negative terminal) are shown below when a 3 V lithium coin cell is immersed in a neutral or alkaline saliva solution. Note that the saliva is usually neutral.

2H₂O+2e⁻→H₂↑+2OH⁻E₀=−0.83V (1)

O₂+2H₂O+4e⁻→4OH⁻E₀=−0.4V (2)

Typically, reaction (1) dominates because the concentration of oxygen in the saliva is too low as the solubility of oxygen in water is limited. Either way, the production of hydroxyl ions (i.e., OH⁻) increases the pH of the saliva, potentially to a point that may cause alkaline burning of the esophagus.

On occasion, saliva may be acidic in nature. In such situations, the reactions at the coin cell cup 12 are shown below:

2H⁺+2e⁻→H₂↑E₀=−0.0V (1a)

O₂+4H⁺+4e⁻→2H₂O E₀=1.23V (2a)

In either case, selection of materials for use at the negative terminal with high hydrogen gas evolution overpotential will shift the dominant reaction from (1) and (2) to (1a) and (2a). This has the beneficial effect of reducing or eliminating the hydroxyl formation that can cause localized alkaline burning of esophageal tissues.

Possible electrochemical reactions on the coin cell can 20 (positive terminal) are shown below when a 3V lithium coin cell is immersed in saliva solution 5 and coin cell can 20 comprises nickel at least partially along its surface.

4OH⁻−4e⁻→O₂↑+2H₂O (3)

Ni−2e⁻+2OH⁻→Ni(OH)₂ (4)

Reaction (4) usually dominates so that the metal constituents in coin cell can 20 tend to oxidize. Indeed, lithium electrochemical coin cell cans are typically nickel-plated, as exemplified by the oxidation of nickel in reaction (4). If coin cell can 20 is composed of other metals, e.g., stainless steel, the iron in these alloys likely will oxidize in a similar reaction. Once the metal surface of coin cell can 20 has been passivated (i.e., by formation of a dense oxide film on the bare metal surface), the oxygen evolution reaction (3) will likely dominate if the voltage is sufficiently high.

Moreover, as shown below in (3a) and (4a), dissolution of the metal can 20 is also a probable result if the ferrous base metal (normally some type of steel) is exposed and especially to the extent that hydroxide is present (e.g., by way of the aforementioned competing reactions) and/or in an acidic environment (e.g., by way saliva).

Fe−2e⁻−Fe²⁺ (in acidic media) (3a)

Fe−2e⁻+2OH⁻→Fe(OH)₂ (in alkaline media) (4a)

Any combination of the cathodic processes in reactions (1) through (2a) and anodic processes in reactions (3) through (4a) can complete the electrolysis cell 6 depicted in FIG. 1. For example, the combination of (1) and (3) leads to the following electrolysis reaction in water (i.e., water splitting):

2H₂O→H₂↑+O₂↑E₀=−1.23V (5)

Note that electrolysis reaction (5) has a thermodynamic potential of 1.23 V and the negative sign for ΔE₀ denotes that the reaction is not spontaneous. Consequently, a DC power source of at least 1.23 V is needed to initiate and sustain reaction (5), as depicted in FIG. 1, coin cell 6 supplies 3V DC.

Furthermore, if the amount of sodium chloride (NaCl) in the saliva is relatively high, the following electrolysis reaction may occur instead of reaction (5) (discussed earlier):

2NaCl+2H₂O→Cl₂↑+H₂↑+2NaOH (6)

In reaction (6), one of the products is sodium hydroxide (NaOH), another contributor to high solution pH and a potentially alkaline solution that may be capable of burning human tissue.

In sum, the conventional electrochemical coin cell 6 depicted in FIG. 1, and the reactions (1) through (6) associated with its submersion in saliva 5, demonstrate that hydroxide ions are formed from some iteration of electrolysis. Thus, the burns and injuries caused when a coin cell becomes accidentally lodged in the esophagus is likely caused by the high saliva pH created during these reactions, although the reactions and corresponding impact on pH may be highly localized and difficult to detect if the pH is not measured in close proximity to the components at issue. Stated differently, because of mass transport limitations in the esophagus, a person with a lodged coin cell may experience different pH values for the tissue interacting with coin cell can 20 (positive terminal) and the tissue interacting with coin cell cup 12 (negative terminal), with higher pH solutions facing the negative terminal (i.e., coin cell cup 12 in FIG. 1) because of diffusion limitations of the liquids within the esophagus.

To the extent certain aspects of various embodiments of the present disclosure and underlying concepts involve saliva and/or saliva-based aqueous solutions, saliva can be represented by the following composition: 0.4 g KCl; 0.4 g NaCl; 0.906 g CaCl₂; 0.560 g Na₃PO₄⁻12H₂O; 2 ml 10% H₃PO₄; 0.0016 g Na₂S; 1 g urea; and a balance of de-ionized water to make 1 liter of solution. While this formulation is intended to approximate human saliva in a manner that is standardized, small variations and or actual human saliva may be used as substitutes although, in such instances, deviations from the representative formulation will be duly noted.

A first aspect of the disclosed approach is to mitigate or eliminate the damaging electrochemical mechanisms that may lead to injuries from inadvertent coin cell ingestion through the selection of materials and cell design considerations. For example, materials or material combinations for the exterior of the coin cells according to the present disclosure hinder or prevent these alkalizing electrochemical reactions from occurring. Selecting these material combinations to mitigate or eliminate these electrochemical reactions is a complex endeavor, requiring a thorough understanding of the principal factors that affect the reaction and damage mechanisms. Additionally, the selections cannot be arbitrary and proper consideration must be given to the chemical compatibility, cost and ease of high speed and high volume manufacturing techniques inherent to the battery industry.

In some embodiments, the electrochemical coin cells disclosed according to the invention reduce the likelihood that the cathodic processes in reactions (1) and (2), or (1a) and (2a), occur on the coin cell cup 12 in FIG. 1. Fundamental testing of the material combinations referenced for these novel cells substantiates this conclusion. For example, employing coin cell positive and negative terminal materials with high overpotential for the reactions in (1) and (2), and (1a) and (2a), and/or increasing the overpotential for metallic oxidation (M−ne⁻→Mⁿ⁺, where M denotes a metallic material used for the positive terminal surface) reduces or eliminates these electrochemical reactions, keeping all other factors constant, including the ˜3V DC from the coin cell itself.

Another approach is to select cell electrode materials that may be prone to dissolution, oxygen evolution and the production of insoluble, non-hydroxide reaction products (at least to a modest degree) when submersed in saliva under 3 VDC. Formation of such insoluble, non-hydroxide reaction products would occur preferentially or exclusively, thereby inhibiting the unwanted hydroxyl reactions noted above. In this approach, a sufficient amount of the selected material should be provided to ensure that the base material (i.e., the material that is prone to electrolysis) is not exposed for substantial periods of time in which the coin cell might still be outputting a voltage above the desired or safe level, typically 2.8 volts or 2.0 volts.

In another embodiment, the selected materials may be clad, coated or deposited on the cell and, more specifically, on surfaces of the cell that are likely to be exposed to saliva in the event of accidental ingestion. Formation of such coatings must be complete and uniform, as even small fissures, pinholes, or other imperfections might provide sufficient reaction sites for the unwanted reactions to occur along the underlying base material. If complete coverage is not achieved or if the coating degrades in situ (i.e., owing to anodic bias, reaction with saliva, etc.), then such coatings will not be suitable. While components made of solid gold exhibit the desired properties, gold coatings of about 1.4 microns (approximately 56 microinches) may not be sufficient to provide consistent and repeatable performance.

As used throughout this specification, irrespective of whether in reference to the anode or the cathode container, the term “cladding” or “cladded layer” refers to a continuous, standalone layer of a material that is free or essentially free from any pin holes or other imperfections. Thus, as a non-limiting example, a titanium-cladded stainless steel would comprise a discrete layer of titanium that is attached to a stainless steel substrate through any variety of means (e.g., mechanical, chemical, adhesive, welding, etc.). Among other things, the use of cladded materials such as these enables the selection of a substrate that is better suited to a particular manufacturing process. Again, as a non-limiting example, the selected cladded-material might possess the desired overpotential and other characteristics of an electrolysis-resistant container (as described throughout this specification) whereas the substrate might exhibit magnetic properties. Obviously, the orientation of the cladded-material versus the substrate will be such so that the exterior of the component/container will be consistent with embodiments of the current disclosure, while at the same time, the inner-facing portions of the substrate will be compatible and non-reactive with the cell active materials and electrolyte.

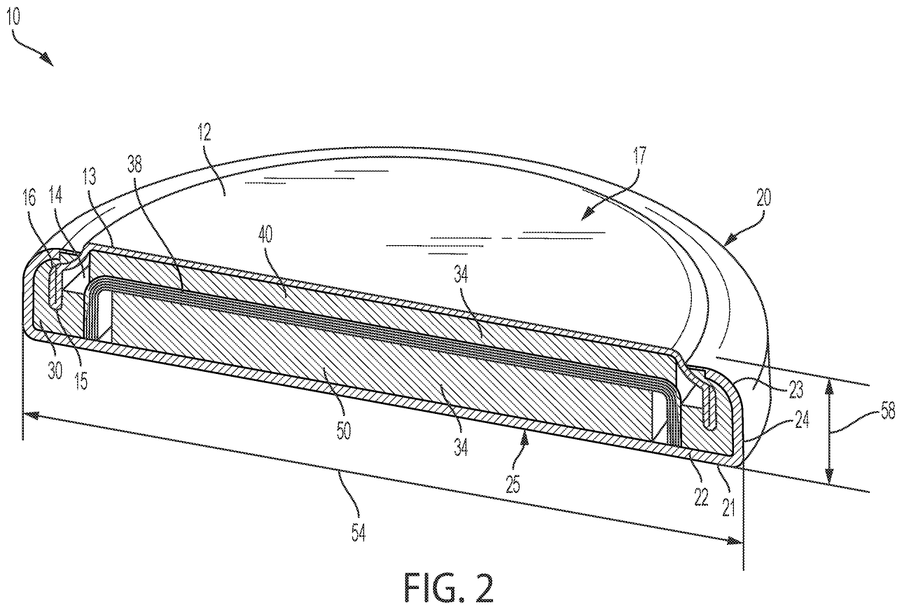

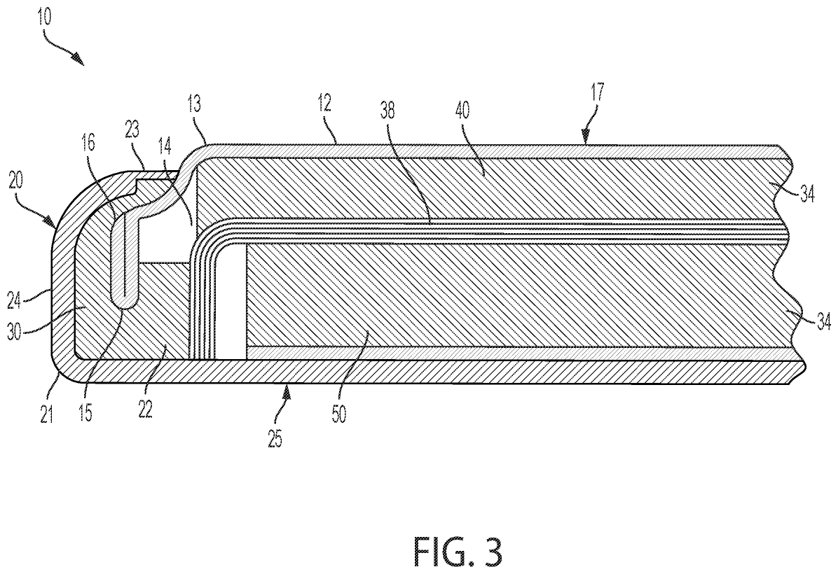

Notably, the use of cladded materials may result in an exposed edge, e.g., the terminal edge 23 shown in FIGS. 2 and 3, where a cross-section including both the cladded layer and the substrate is potentially exposed in a manner that is not desired. In such cases, a sealant may be applied in order to block any unwanted reactions. For example, a polymeric sealant, and more preferably UV-curable sealants, can be applied around the rim and gasket area to cover the exposed edge.

FIGS. 2 and 3 depict one arrangement for an electrochemical coin cell 10 that is well-suited to aspects and embodiments of the present disclosure, although the electrochemical coin cell 10 may assume various alternative orientations and arrangements of components. Further, the specific devices and processes illustrated in the attached drawings and described herein are exemplary embodiments of the inventive concepts defined in the appended claims. Hence, precise dimensions and physical characteristics relating to the embodiments disclosed herein are not to be considered as limiting except to the extent that such dimensions or characteristics are inherent to producing the desired reactions.

Electrochemical coin cell 10 includes an anode terminal 12 (i.e., the cell cap or cup) including a closed end 13, an open end 14 with a terminal edge 15, and side wall 16 extending between closed end 13 and open end 14 (FIGS. 2 and 3). In the nomenclature of a battery, anode terminal 12 serves as the negative electrode for the electrochemical coin cell 10. Further, anode terminal 12 is comprised of an electron-conducting material that is resistant to electrochemical reactions that form hydrogen gas upon exposure to saliva-containing solutions (e.g., saliva solution 5). For example, anode terminal 12 may be made of a copper-tin-zinc alloy (e.g., between about 40 wt. % and about 65 wt. % Cu, between about 30 wt. % and about 45 wt. % Sn, and/or between about 4 wt. % and about 15 wt. % Zn), nickel metal, stainless steel, and/or another electronic conductor that has high hydrogen gas evolution overpotential. Further, materials for anode terminal 12 may be selected that possess an onset potential for hydrogen gas evolution in saliva in the approximate range of −0.66V to −1.96V vs. a standard hydrogen electrode (SHE). Preferably, the material selected for anode terminal 12 exhibits an onset potential for hydrogen gas evolution in saliva significantly lower than −0.66V and closer to −1.96V vs. SHE.

The electrochemical coin cell 10, as depicted in FIGS. 2 and 3, also includes a cathode terminal 20 (i.e., the cell can) including a closed end 21, an open end 22 with a terminal edge 23, and a side wall 24 extending between closed end 21 and open end 22. Cathode terminal 20 serves as the positive electrode for the coin cell. In addition, cathode terminal 20 is comprised of an electron-conducting material resistant to metallic dissolution and electrochemical reactions that form oxygen gas upon exposure to saliva-containing solutions. In particular, cathode terminal 20 may be formed of titanium, a titanium alloy, titanium nitride, tantalum, niobium, gold, boron-doped diamond, or another electronic conductor that resists metallic dissolution upon an anodic bias and preferably has high oxygen gas evolution overpotential. Closed end 21 may also be provided with a composition comprising titanium metal, a titanium alloy, titanium nitride, tantalum, niobium, gold, boron-doped diamond, or another electronic conductor that resists metallic dissolution upon an anodic bias and preferably has high oxygen gas evolution overpotential. Further, materials for cathode terminal 20 may be selected that possess an onset potential for anodic reactions in saliva in the approximate range of +0.6V to +2.4V vs. SHE. Preferably, the material selected for cathode terminal 20 exhibits an onset potential for anodic reactions in saliva significantly higher than +0.6V and closer to +2.4V vs. SHE.

While localized PH levels are believed to be responsible for the injuries caused by ingested cells, experimental results have demonstrated that measurement of pH values alone may be insufficient to determine the efficacy of any proposed solution. The inventors have determined that pH changes are sensitive to experimental conditions, including exposed surface area of the positive and negative terminals, quantity of saliva present, and the means and location of the pH measurement device. Thus, any pH measurements are most useful when considered in a comparative context only. At present, the inventors are unaware of any published and standardized clinical test regimen for mimicking or quantifying the effect of coin cell ingestion on the human body.

Another means for evaluating the extent of unwanted electrolytic activity between the terminals when a “live” cell is placed in saliva is to quantify the amount of metal that has been dissolved into the saliva solution. As an example, elemental analysis by Inductively Coupled Plasma (ICP) mass spectrometry can be used to determine the presence of metallic species. In the same manner, such quantification measurements are also useful in determining the efficacy of coatings or cladded materials.

The electrochemical coin cell 10 may further include a gasket 30 that provides a seal between anode terminal 12 and cathode terminal 20 (FIGS. 2 and 3). The gasket 30 is typically made from an electrically nonconductive, elastomeric material, capable of providing a compressive seal between anode terminal 12 and cathode terminal 20. The material used for the gasket 30 may be selected with reference to its stability in the presence of an electrolyte, its resiliency, and its resistance to cold flow. Suitable materials for gasket 30 include the following: nylon, polytetrafluoroethylene, fluorinated ethylene-propylene, chlorotrifluoroethylene, perfluoroalkoxy polymer, polyvinyl, polyethylene, polypropylene, polystyrene, polysulfone and the like.

The electrochemical coin cell 10 also includes an electrolyte 34. Various materials can be employed for electrolyte 34 as understood by one with ordinary skill in the art. For example, electrolyte 34 may be composed of a composition of at least one lithium salt dissolved in an organic solvent or a blend of organic solvents. Suitable salts for use in lithium coin cells are lithium trifluoromethanesulfonate, lithium trifluoromethanesulfonimide, lithium perchlorate, lithium tetrafluoroborate, lithium hexafluorophosphate, or their combination. Common organic solvents used in lithium coin cells are propylene carbonate and 1,2-dimethoxyethane.

The electrochemical coin cell 10 also has an anode 40 disposed in electrical connection with anode terminal 12. As understood by those with ordinary skill in the art, the anode 40 can be composed of various alkaline metals and their alloys with aluminum or magnesium provided that the composition is suitable for serving as an anode in an electrochemical cell. In one embodiment, anode 40 is primarily composed of lithium material suitable as an anode in an electrochemical cell with a cathode that consists primarily of manganese dioxide.

The electrochemical coin cell 10 also includes cathode 50 arranged to be in electrical connection with cathode terminal 20. As also understood by those with ordinary skill in the art, cathode 50 can be composed of various materials suitable for use as a cathode in a lithium-based electrochemical cell. In one embodiment, cathode 50 is primarily composed of manganese dioxide.

The electrochemical coin cell 10 can further include a separator 38 disposed between anode 40 and cathode 50 for providing insulation therebetween. Separator 38 can be composed of any of a variety of polymeric materials, for example, which provide electrical insulation between anode terminal 12 and cathode terminal 20. For example, separator 38 may be formed from a polypropylene or polyethylene nonwoven film with thickness of between about 20 μm and about 60 μm.

As also demonstrated by FIGS. 2 and 3, electrochemical coin cell 10 can be configured in a button-cell configuration, coin-cell configuration, or any other suitable configuration. In some embodiments, the electrochemical coin cell 10 can have dimensions defined at least in part by a total cell external diameter 54 and total cell height 58. The total cell external diameter 54 may be sized from between about 5 mm and about 25 mm and the total cell height 58 may be between about 0.5 mm and about 10 mm. It is generally understood that button or coin cells with these dimensions are most likely to lodge in the esophagus upon accidental ingestion. For example, electrochemical coin cell 10 may be made in a CR2016 configuration as defined by the International Electrotechnical Commission (IEC) with total cell external diameter 54 having a diameter of about 20 mm and total cell height 58 having a thickness of about 1.6 mm.

Another embodiment relates to an electrolysis-resistant lithium primary cell having an initial open circuit voltage in excess of 2.0 volts and, more preferably, in excess of 2.8 volts. Alternatively, the lithium primary cell has a nominal voltage of about 3.0 volts and/or of about 2.8 volts. The surface of the externally exposed components of this cell will comprise materials that possess the requisite hydrogen overpotential and/or other characteristics relating to electrolysis reactions, and more specifically unwanted electrolysis under exposure to saliva, as described above. All of the additional features, components and characteristics described in the preceding paragraphs above are applicable to this embodiment.

Another embodiment relates to an electrochemical cell having an open circuit voltage in excess of 2.0 volts and, more preferably, in excess of 2.8 volts. Alternatively, the lithium primary cell has a nominal voltage of about 3.0 volts and/or of about 2.8 volts. The exposed exterior of the cell, and more specifically, the exterior surface of the negative electrode container and the positive electrode container, comprises materials that do not evolve hydroxide and/or otherwise cause electrolysis of the aqueous solution. For example, the materials for, e.g., the negative container exterior may possess the requisite hydrogen overpotential and/or other characteristics relating to electrolysis reactions, and more specifically unwanted electrolysis under exposure to saliva, all as described in the preceding above. All of the additional features, components and characteristics described above are applicable to this embodiment.

Another aspect of the disclosed approach relates to a method of constructing and/or manufacturing of an electrolysis-resistant coin cell. The method comprises providing a negative electrode active material comprising lithium and disposing said materials in separate halves of an electrically conductive container and providing a nonaqueous, organic liquid electrolyte prior to hermetically sealing the halves of the conductive container to create a battery. The compositions of the halves of the conductive container are selected to possess the requisite hydrogen overpotential and/or other characteristics relating to electrolysis reactions, and more specifically unwanted electrolysis under exposure to saliva, all as described above.

Another aspect of the disclosed approach is the provision and/manufacture of an electrolysis resistant battery to avoid injuries associated with ingestion of said battery, as well as a method of for avoiding injuries caused by battery ingestion. In these aspects, any of the aforementioned battery designs and constructions may be provided. At their core, the inventive method involves manufacturing an electrolysis resistant battery and providing said battery for sale and/or use by a consumer.

As used throughout this specification, any reference to particular grades should be presumed to be with reference to the standards published by ASTM International, unless the context indicates some other reference known to those having ordinary skill in the field of metallurgy. In view of the foregoing, as well as all of the information contained in the examples below, an electrochemical coin cell having ANY combination of the following traits is contemplated:
an anode and, more preferably, an anode disposed in electrical connection with the anode terminal;
the anode comprising a material selected from the group consisting of lithium and lithium alloys;
a cathode and, more preferably, a cathode disposed in electrical connection with the cathode terminal;
the cathode comprising manganese dioxide;
an electrolyte and, more preferably, an electrolyte comprising a nonaqueous material capable of facilitating electrochemical reactions producing an open circuit voltage in excess of about at least 2.8 volts or a nominal voltage of about 3.0 volts;
a gasket and, more preferably, a gasket disposed and providing a seal between the anode terminal and the cathode terminal;
a separator disposed between the anode and the cathode and, more preferably, also providing electrical insulation between the anode and the cathode;
a total cell external diameter of between about 5 mm and about 25 mm, and a total cell external height of between about 0.5 mm and about 10 mm;
an anode terminal comprising a closed end, an open end with a terminal edge and a side wall extending between the closed and open ends of the anode terminal, wherein the closed end of the anode terminal: (a) is configured as an electronic conductor and comprising a material that is resistant to reactions forming hydrogen gas during exposure to a saliva-containing solution and/or (b) consists essentially of an electronic conductor resistant to reactions forming hydrogen gas during exposure to a saliva-containing solution;
a cathode terminal comprising a closed end, an open end with a terminal edge and a side wall extending between the closed and open ends of the cathode terminal, the closed end of the cathode terminal: (a) is configured as an electronic conductor and comprising a material that is resistant to metallic dissolution and reactions forming oxygen gas during exposure to the saliva-containing solution and/or (b) consists essentially of an electronic conductor resistant to metallic dissolution and reactions forming oxygen gas during exposure to the saliva-containing solution;
wherein the closed end of the anode terminal comprises or consists essentially of a material with substantial hydrogen gas evolution overpotential during exposure to the saliva-containing solution and, more preferably, wherein the material with substantial hydrogen gas evolution overpotential during exposure to the saliva-containing solution exhibits an onset potential for hydrogen gas evolution in the saliva-containing solution in the range of about −0.66V to about −1.96V versus a standard hydrogen electrode; wherein the closed end of the anode terminal comprises or consists essentially of a material that conducts electrons and is resistant to reactions forming hydrogen gas during exposure to the saliva-containing solution and, more preferably, wherein the material with substantial hydrogen gas evolution overpotential during exposure to the saliva-containing solution exhibits an onset potential for hydrogen gas evolution in the saliva-containing solution in the range of about −0.66V to about −1.96V versus a standard hydrogen electrode;
wherein the closed end of the cathode terminal comprises or consists essentially of a material that resists metallic dissolution and has substantial oxygen gas evolution overpotential during exposure to the saliva-containing solution and, more preferably, wherein the material that resists metallic dissolution and has substantial oxygen gas evolution overpotential during exposure to the saliva-containing solution exhibits an onset potential for anodic reactions in the saliva-containing solution in the range of about +0.6V to about +2.4V versus a standard hydrogen electrode;
wherein the closed end of the cathode terminal comprises or consists essentially of a material that conducts electrons and is resistant to reactions causing metallic dissolution and forming oxygen gas during exposure to the saliva-containing solution and, more preferably, wherein the material that resists metallic dissolution and has substantial oxygen gas evolution overpotential during exposure to the saliva-containing solution exhibits an onset potential for anodic reactions in the saliva-containing solution in the range of approximately +0.6V to +2.4V versus a standard hydrogen electrode;
wherein the closed end of the anode terminal consists essentially of nickel metal, stainless steel or a copper-tin-zinc alloy containing 30 to 45% tin and 4 to 15% zinc alloying elements by weight;
wherein the closed end of the cathode terminal consists essentially of materials selected from the group consisting of titanium metal, titanium alloy, titanium nitride, tantalum, niobium, gold, and boron-doped diamond.

Additionally, in view of the foregoing and the information contained in the examples below, an electrochemical coin cell having ANY combination of the following traits is contemplated:
internal components including an anode, a separator, and a cathode capable of producing an output open circuit voltage of about at least 2.8 voltage in the presence of a non-aqueous electrolyte;
a flat cylindrical container encasing the internal components having an external diameter between about 5 mm and about 25 mm and an external height of between about 0.5 mm and about 10 mm, the container comprising an anode terminal casing and a cathode terminal casing with an electrically insulating gasket disposed therebetween;
wherein the anode terminal casing has an internal surface which maintains electrical contact with the anode and an external surface comprising a material that is resistant to reactions forming hydrogen gas during exposure to a saliva-containing solution;
wherein the cathode terminal casing has an internal surface which maintains electrical contact with the cathode and an external surface comprising a material that is resistant to metallic dissolution and reactions forming oxygen gas during exposure to the saliva-containing solution;
wherein the anode includes an active material consisting essentially of lithium or a lithium-based alloy and the cathode includes an active material comprising manganese dioxide;
wherein the external surface of the anode terminal casing exhibits an onset potential for hydrogen gas evolution in the saliva-containing solution in the range of approximately −0.66V to −1.96V versus a standard hydrogen electrode; wherein the external surface of the anode terminal casing is selected from the group consisting of: nickel metal, stainless steel and a copper-tin-zinc alloy containing between about 30% to about 45% tin and between about 4% to about 15% zinc alloying elements, by weight;
wherein the external surface of the cathode material casing exhibits an onset potential for anodic reactions in the saliva-containing solution in the range of approximately +0.6V to +2.4V versus a standard hydrogen electrode; and/or
wherein the external surface of the cathode terminal casing is selected from the group consisting of: titanium metal, titanium alloy, titanium nitride, tantalum, niobium, stainless steel, gold, and boron-doped diamond.

Additionally, in view of the foregoing and the information contained in the examples below, a method of manufacturing a coin-shaped battery having an external diameter of 5-25 millimeters and an external height of between about 0.5 mm and about 10 mm that is resistant to electrolysis when placed in an aqueous solution initially having a neutral pH, having any combination of the following traits is contemplated:
disposing an anode material comprising lithium or lithium alloy inside of a container having an anode terminal, wherein the entire external surface of the anode terminal is made from a material that is resistant to reactions forming hydrogen gas when the final, manufactured cell is submerged;
disposing a cathode material inside of a container having a cathode terminal, wherein the entire external surface of the cathode terminal is made from a material that is resistant to metallic dissolution and reactions forming oxygen gas when the final, manufactured cell is submerged;
positioning a separator and insulating gasket between the anode and the cathode and sealing the container to create a final, manufactured cell;
wherein the external surface of the anode terminal is selected to exhibit an onset potential for hydrogen gas evolution when the final, manufactured cell is submerged in the range of approximately −0.66 V to −1.96 V versus a standard hydrogen electrode;
wherein the external surface of the cathode terminal is selected to exhibit an onset potential for anodic reactions when the final, manufactured cell is submerged in the range of approximately +0.6V to +2.4V versus a standard hydrogen electrode; and/or
wherein the external surface of the cathode terminal is selected from the group consisting of: titanium metal, titanium alloy, titanium nitride, tantalum, niobium, stainless steel, gold, and boron-doped diamond.

Finally, in view of the foregoing and the information contained in the examples below, a coin-shaped battery having an external diameter of between about 5 mm and about 25 mm and an external height of between about 0.5 mm and about 10 mm that is resistant to electrolysis when placed in an aqueous solution initially having an initial pH of about 7.0 or less, has any combination of the following traits is contemplated:
an exposed surface of an anode terminal consisting essentially of: nickel metal, stainless steel, a copper-tin-zinc alloy containing about 30 wt. % to about 45 wt. % tin, and about 4 wt. % to about 15 wt. % zinc alloying elements by weight or combinations thereof;
an exposed surface of a cathode terminal consisting essentially of: titanium metal, titanium alloy, titanium nitride, tantalum, niobium, gold, and boron-doped diamond, or combinations thereof; and
further comprising an anode active material having lithium and a cathode active material having manganese dioxide.

The nature of various embodiments of the current disclosure, its use and advantages are further demonstrated in the following examples that compare the results from electrolysis tests of conventional electrochemical cells to novel cells constructed by the inventors. These novel cells are examples of the present disclosure and reflect the inventors' discovery of the electrochemical mechanisms underlying the damage caused by inadvertent coin cell ingestion and lodging in the esophagus.

Coin cell batteries, such as those described above (e.g., electrochemical coin cell 10), are typically manufactured by forming a positive portion of a coin cell housing or coin cell casing from a sheet or strip of a metallic material. The positive portion of the coin cell housing or casing includes a positive terminal or contact. The positive portion of the coin cell housing or casing can include side walls. The positive portion of the coin cell housing or casing can be formed by pressing or punching the sheet or strip of metallic material over or into a die, under a die, between two dies, and/or the like. The positive terminal or positive can may be formed from the same sheet or strip of metallic material at the same time as the side walls, or the positive terminal or positive may be formed separately from the side walls and later joined to the side walls to form the positive portion of the coin cell housing or casing.

A negative portion of the coin cell housing or casing for the coin cell battery (e.g., electrochemical coin cell 10) can have a form factor that is similar to to that of the positive portion of the coin cell housing or casing. Alternatively, the negative portion of the coin cell housing or casing can have a form factor that is differently formed in a manner that is similar to, that used for forming the positive portion of the coin cell housing or casing. For example, the positive portion of the coin cell housing or casing can have a flat or substantially flat portion that comprises a contact, such as a positive contact or terminal. As with the positive portion, the negative portion of the coin cell housing or casing can include side walls. The negative portion of the coin cell housing or casing can be formed by pressing or punching a sheet or strip of metallic material over or into a die, under a die, between two dies, and/or the like. The negative terminal or negative can may be formed from the same sheet or strip of metallic material at the same time as the side walls, or the negative terminal or negative can may be formed separately from the side walls and later joined to the side walls to form the negative portion of the coin cell housing or casing.

Alternatively, the positive portion or the negative portion of the coin cell housing or casing for a coin cell battery (e.g., electrochemical coin cell 10) can include a flat portion that comprises the positive or negative contact or terminal.

The positive portion of the coin cell housing or can may, e.g., form an inner volume of a positive can for the coin cell. The negative portion of the coin cell housing or casing may, e.g., when including both the negative contact or terminal and the side wall(s), form an inner volume of the negative portion of the coin cell housing or casing. The inner volume of the negative portion and/or the inner volume of the positive portion of the coin cell housing or casing can be dimensioned and configured to contain, retain, house, or otherwise accommodate at least a portion of one or more internal components of the coin cell battery. The internal components may include a cathode, an anode, a separator, one or more current collectors, an electrolyte, and/or other components, structures, or materials. The internal components may include but are not limited to features, structures, and materials that contribute to the electrochemical functionality of the coin cell battery.

The coin cell battery (e.g., electrochemical coin cell 10) may be formed by disposing all or some of the internal components into the inner volume of the negative portion and/or the positive portion of the coin cell housing or casing, and joining the positive portion to negative portion of the coin cell housing or casing in order to substantially seal the internal components of the coin cell battery within an inner volume of the coin cell housing or casing, the inner volume of the coin cell housing or casing being defined at least by the inner volumes of the negative can and positive can of the coin cell housing or casing.

To join the negative and positive portions of the coin cell housing or casing together, a portion of one or both side walls of the positive/negative portions of the coin cell housing or casing may be crimped, bent, folded, rolled, wrapped, or otherwise partially physically entangled or interposed. For example, a top edge of the side wall of the negative portion and/or the positive portion of the housing or casing may be bent or folded together to form a seal.

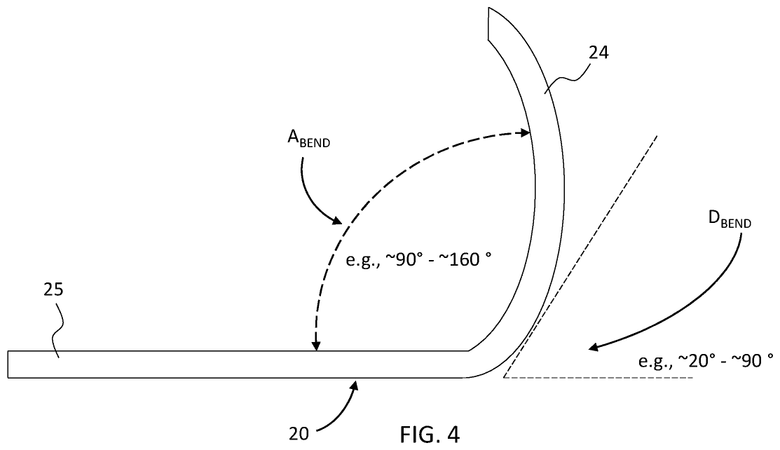

Referring now to FIG. 4, the bending of a sheet of material to form the negative portion or positive portion of the coin cell housing or casing may form a bend angle A_{BEND}. Additionally or alternatively, the bending of a sheet of material to form the negative or positive terminal for the coin cell battery (e.g., electrochemical coin cell 10) can form the bend angle A_{BEND}. The bend angle A_{BEND} can be an acute angle or an obtuse angle, as needed based upon the particular form factor of the negative portion or positive portion of the coin cell battery and/or based upon the particular method for joining the negative and positive portions of the coin cell housing or casing together. In some instances, such as when forming a coin cell battery (e.g., electrochemical coin cell 10) that has a rounded corner (e.g., 20 or 21) between the side wall and a terminal (e.g., 17 or 25), the bend angle A_{BEND} can be less than about 90°. As used herein, the term “bend angle” (e.g., the bend angle A_{BEND}) may refer to an internal radial space between two intersecting lines about a point of intersection. In some embodiments, the bend angle A_{BEND} is less than about 180°, less than about 135°, less than about 90°, less than about 80°, less than about 70°, less than about 60°, less than about 50°, less than about 40°, or less than about 30°, inclusive of all values and ranges therebetween and therewithin.

The A_{BEND} may form a degree of bending D_{BEND} that is defined as an external angle formed between an original plane of a bent portion of the sheet or strip, and the final bent portion of the sheet or strip. In some embodiments, the degree of bending D_{BEND} can be greater than about 20°, greater than about 40°, greater than about 60°, greater than about 80°, greater than about 90°, or greater than about 100°, inclusive of all values and ranges therebetween and therewithin.

Additionally or alternatively, the joining of the negative and positive portions of the coin cell housing or casing together, such as by crimping, bending, folding, rolling, wrapping, or otherwise partially physically entangling or interposing the negative and positive portions of the coin cell housing or casing together may form the bend angle A_{BEND}.

When the bend angle A_{BEND} refers to a small internal angle, the stress of bending, crimping, joining, or other physical forming of a material into portions of a coin cell battery (e.g., electrochemical coin cell 10) can cause material strain in desired and/or undesired ways. For example, the bending force applied to a sheet or strip of a metal-containing material to achieve the bend angle A_{BEND} may result in the successful and desired bending of the sheet or strip of the metal-containing material. Conversely, the bending force applied to a sheet or strip of the metal-containing material to achieve the bend angle A_{BEND} may result in a thinning of the sheet or strip of the metal-containing material at an apex of the bend. In some instances, the bending force applied to a sheet or strip of the metal-containing material to achieve the bend angle A_{BEND} may result in the shearing of a portion of the bent material within or along a setback from the apex of the bend.

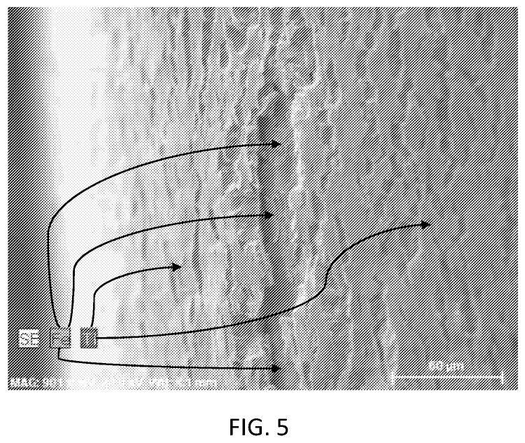

FIG. 5 illustrates a bi-clad strip of material comprising an iron-containing material covered in a titanium-containing material. The reason for using such a bi-clad strip of material comprising an iron-containing material covered in a titanium-containing material is, among other things, that the titanium-containing material may be more resistant to alkalizing reactions such as those described elsewhere herein, whereas the iron-containing material may be more prone to causing such alkalizing reactions when a coin cell battery is swallowed or otherwise comes into contact with a bodily fluid. As such, by coating the iron-containing material in a titanium-containing material, the aim is to reduce or eliminate such alkalizing reactions in the event that the coin cell battery is swallowed or otherwise comes into contact with bodily fluids. However, small radii and large bends may be required when forming and/or joining the positive portions of the housing or casing of a coin cell battery (e.g., electrochemical coin cell 10), such as when die stamp forming the same or bending a portion of the side walls of the positive portion to seal the positive portion to seal the coin cell battery shut. Such bends and/or crimps of the material, such as when forming or joining a positive portion of the housing or casing can cause cracks or tears to form, such as the vertically oriented tear illustrated in FIG. 5. When such a tear occurs due to bending or crimping/joining of materials used in a positive portion of a coin cell battery (e.g., electrochemical coin cell 10) during manufacturing of the coin cell battery, the titanium-containing material covering the iron-containing material may no longer prevent exposure of the iron-containing material to bodily fluid(s). This may mean that the undesirable alkalizing reactions may still occur if such a coin cell battery is swallowed or otherwise comes into contact with bodily fluid(s).

Many other materials besides titanium are contemplated to be usable for forming coin cell battery components (e.g., cathode terminal 20) based on their resistance to electrolysis reactions and hydroxide formation when coin cell batteries comprising these contacts/terminals are exposed to saliva or the like, such as certain grades of titanium and titanium alloys. However, each of the materials was contemplated as being usable for covering another material, typically an iron-containing material, which would otherwise have been used to form the coin cell battery contacts or terminals. Each of these materials, when used as a covering or coating for an iron-containing terminal/contact material, will develop cracks during formation of the positive portion of the housing or casing, and/or when joining the positive/negative portions of the housing or casing of the coin cell battery (e.g., electrochemical coin cell 10). For example, foils and strips made of commercially pure (CP) grade 2 titanium, which is the most common titanium, was found to develop several cracks during formation of a positive portion of a housing or casing for a coin cell battery. Using a bi-clad foil, strip, or sheet comprising stainless steel and ASTM grade 2 titanium was also found to develop severe cracks at one or more corners of the positive portions of the housing, such as shown in the image of FIG. 5. Thus, materials that are not resistant to such alkalizing reactions, electrolysis reactions, and/or hydroxide forming reactions, such as stainless steel or other iron-containing materials, are then exposed to saliva, tissue fluids, or other bodily fluids, causing the undesirable electrolysis reactions and a high pH on the negative contact or terminal of the coin cell battery.

Using coatings of Ti or TiN on a stainless steel substrate also resulted in the formation of cracks, pinholes, or scratches on the surface of the coating during formation of the positive/negative portion(s) of the casing or housing of the coin cell battery (e.g., electrochemical coin cell 10). Thus, the stainless steel substrate is not fully covered by Ti or TiN, causing electrolysis reactions and high pH on a terminal (e.g., anode terminal 12) when the coin cell battery is in contact with bodily fluid(s).

Surprisingly, certain materials and material combinations were found to provide a solution to making components (e.g., cathode terminal 20) for coin cell batteries (e.g., electrochemical coin cell 10) that are resistant to alkalizing/electrolysis reactions, and which experience less or no cracking or other destructive material strain during formation of the terminal (or cathode terminal 20) and/or other components of the casing or housing (e.g., closed end 21, side wall 24, exterior surface 25 of the closed end 21) for the coin cell battery (e.g., electrochemical coin cell 10) and/or assembly of the coin cell battery.

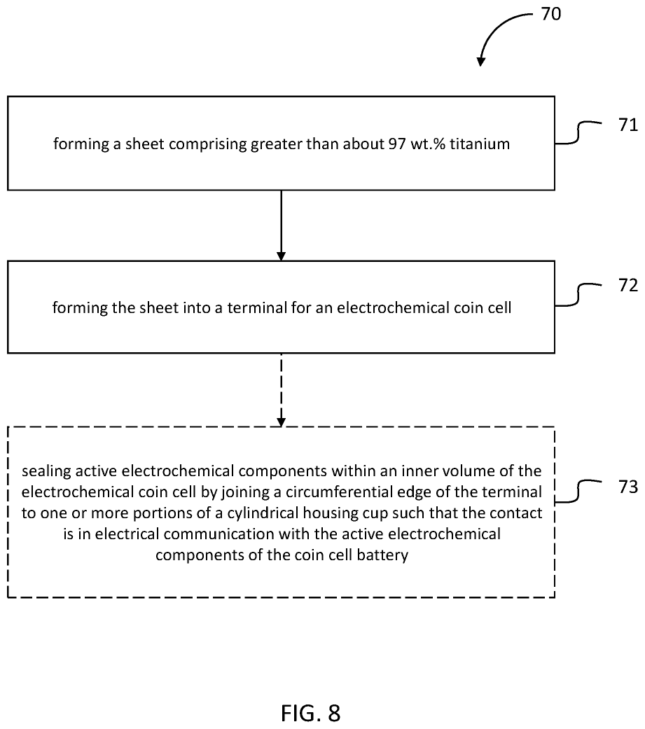

In order to solve these and/or other problems, a coin cell battery (e.g., electrochemical coin cell 10), material for forming at least a portion (e.g., cathode terminal 20) of a coin cell battery (e.g., electrochemical coin cell 10), and associated methods (e.g., 70, 80, 90, 100) are described below, with reference to at least FIGS. 8-11.

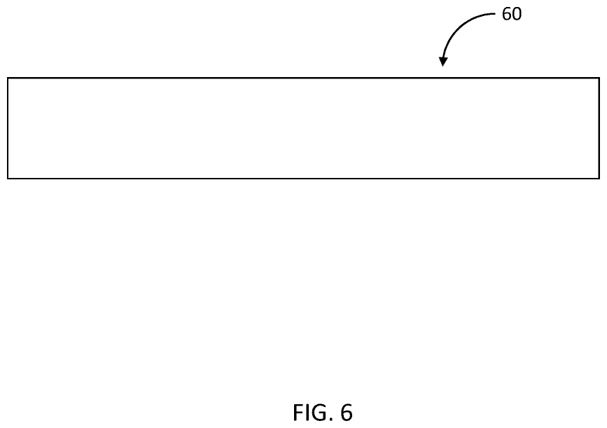

Referring now to FIG. 6, a titanium-based strip 60 is illustrated. In some embodiments, a positive portion of a coin cell battery can be formed from the titanium-based strip 60. The positive portion may comprise, form, function as, or otherwise be a terminal (e.g., cathode terminal 20). The titanium-based strip 60 can have any suitable dimensions, such as a length sufficient to form one or more positive portions, for one or more coin cell batteries (e.g., electrochemical coin cell 10).

In some embodiments, a thickness of the titanium-based strip 60 can be less than about less than about 5 mm, less than about 2 mm, less than about 1.5 mm, less than about 1 mm, or less than about 0.5 mm, less than about 0.4 mm, less than about 0.3 mm, less than about 0.2 mm, or less than about 0.1 mm, inclusive of all values and ranges therebetween and therewithin. In some embodiments, the thickness of the titanium-based strip 60 is about 1.5 mm. In another embodiment, the thickness of the titanium-based strip 60 is about 0.2 mm. In still other embodiments, the titanium-based strip 60 is about 0.3 mm. For example, if the titanium-based strip 60 is to be used in a CR2032 cell that has a total height of between about 2.9 mm and about 3.2 mm, the thickness of the titanium-based strip 60 can be between about 1 mm and about 1.8 mm. In other examples, if the titanium-based strip 60 is to be used in an ECR1216, CR1216, CR1220, BR1225, CR1616, CR1620, CR1632, CR2016, CR2025, CR2430, and/or other such coin cells, such as any 3V cell or the like, the thickness of the titanium-based strip 60 can vary based on the desired total height of the coin cell itself, such as based on a total height to titanium-based strip 60 thickness of between about 5:1 and about 3:1.

In some embodiments, the composition of the titanium-based strip 60 can be adjusted to achieve particular mechanical properties above or below a particular threshold or within a particular range. For example, the composition of the titanium-based strip 60, when adjusted based on the particular wt. % compositional makeup of titanium to other compositional components, such as iron, oxygen, carbon, nitrogen, hydrogen, and/or the like, can result in a titanium-based sheet 60 that has the desired mechanical properties, which were not self-evident with respect to associated durability and cracking prevention prior to experimenting with different material compositions.

In some embodiments, when forming the housing or casing for the coin cell battery or joining the positive/negative portions of the housing or casing for the coin cell battery, a bend can be imparted to the titanium-based strip 60, wherein a bend radius of the bend is between about 50% and about 500% of a thickness of the titanium-based strip 60 (e.g., between about 100% and about 200%). In some embodiments, when a bend is imparted to the titanium-based strip 60, such as according to ASTM Test Method E290, a bend radius of between about 50% and about 500% of a thickness of the titanium-based strip 60 can be imparted before any or substantially any cracking or microcracking is formed in the titanium-based strip 60 (e.g., between about 100% and about 200%). For example, in one embodiment in which the titanium-based strip 60 is to be used in a CR2032 cell in which the thickness of the titanium-based strip 60 is 0.2 mm, the bend radius of the bend can be between about 0.1 mm and about 0.4 mm. In another embodiment in which the titanium-based strip 60 is to be used in a CR2032 cell in which the thickness of the titanium-based strip 60 is 0.3 mm, the bend radius of the bend can be between about 0.15 mm and about 0.6 mm.

In some embodiments, the composition of the titanium-based strip 60 can be adjusted to achieve particular value(s) or range(s) of value(s) for particular mechanical properties of the titanium-based strip 60, such as one or more of: an ultimate tensile strength, an elastic modulus, a breaking elongation, a compressive modulus, a shear modulus, a Poisson's ratio, an annealed fracture toughness, an elongation or percent elongation, an electrical resistivity, and/or the like.

For example, the composition of the titanium-based strip 60 can be adjusted to achieve an ultimate tensile strength of greater than about 30,000 psi, greater than about 40,000 psi, greater than about 50,000 psi, greater than about 60,000 psi, or greater than about 70,000 psi, inclusive of all values and ranges therewithin and therebetween.

For example, the composition of the titanium-based strip 60 can be adjusted to achieve a breaking elongation of between about 10% and about 50%, between about 10% and about 40%, or between about 20% and about 40%, inclusive of all values and ranges therewithin and therebetween. Without wishing to be bound by any particular theory, a percent elongation (also referred to as “% elongation”) may be important for eliminating or reducing crack formation during room temperature (e.g., about 21° C.) formation of a can (e.g., positive can) for a coin cell battery.

For example, the composition of the titanium-based strip 60 can be adjusted to achieve an elastic modulus of greater than about 5,000 ksi, greater than about 10,000 ksi, greater than about 12,000 ksi, greater than about 14,000 ksi, greater than about 16,000 ksi, greater than about 18,000 ksi, greater than about 20,000 ksi, greater than about 25,000 ksi, greater than about 30,000 ksi, or greater than about 35,000 ksi, inclusive of all values and ranges therewithin and therebetween.

For example, the composition of the titanium-based strip 60 can be adjusted to achieve a compressive modulus of greater than about 10,000 ksi, greater than about 12,000 ksi, greater than about 14,000 ksi, greater than about 16,000 ksi, greater than about 18,000 ksi, greater than about 20,000 ksi, greater than about 25,000 ksi, greater than about 30,000 ksi, or greater than about 35,000 ksi, inclusive of all values and ranges therewithin and therebetween.

For example, the composition of the titanium-based strip 60 can be adjusted to achieve a shear modulus of greater than about 1,000 ksi, greater than about 5,000 ksi, greater than about 10,000 ksi, greater than about 15,000 ksi, greater than about 20,000 ksi, greater than about 25,000 ksi, or greater than about 30,000 ksi, inclusive of all values and ranges therewithin and therebetween.

For example, the composition of the titanium-based strip 60 can be adjusted to achieve a Poisson's ratio of between about 0.10 and about 0.70, between about 0.20 and about 0.60, between about 0.30 and about 0.50, between about 0.30 and about 0.40, between about 0.20 and about 0.70, between about 0.30 and about 0.60, or between about 0.25 and about 0.40, inclusive of all values and ranges therewithin and therebetween.

For example, the composition of the titanium-based strip 60 can be adjusted to achieve an annealed fracture toughness of greater than about 30 ksi-in^{1/2}, greater than about 40 ksi-in^{1/2}, greater than about 50 ksi-in^{1/2}, greater than about 60 ksi-in^{1/2}, greater than about 70 ksi-in^{1/2}, greater than about 80 ksi-in^{1/2}, greater than about 90 ksi-in^{1/2}, or greater than about 100 ksi-in^{1/2}, inclusive of all values and ranges therewithin and therebetween.

For example, the composition of the titanium-based strip 60 can be adjusted to achieve an elongation at room temperature (e.g., about 21° C.) of greater than about 20% (e.g., between about 20% and about 50%), inclusive of all values and ranges therewithin and therebetween.

For example, the composition of the titanium-based strip 60 can be adjusted to achieve an electrical resistivity of about 10μΩ·cm, less than about 20μΩ·cm, less than about 50μΩ·cm, less than about 100μΩ·cm, or less than about 200μΩ·cm, inclusive of all values and ranges therewithin and therebetween.

Provided below in Table 1 are several example titanium-based strips (e.g., 60) and the corresponding mechanical properties for each example, where UTS refers to ultimate tensile strength, YS refers to yield strength, EM refers to elastic modulus, SM refers to shear modulus, PR refers to Poisson's Ratio, E refers to Elongation (at room temperature, e.g., about 21° C.), B refers to the minimum bend radius relative to the thickness (T) of the titanium-based strip (e.g., 60), such as 1.8 mm thickness, used for a bend test per American Society for Testing and Materials (ASTM) bend testing protocol E290, R refers to Resistivity, Gr. refers to an example ASTM grade value for either commercially pure (CP) or alloyed materials, and Cl. refers to a Japanese Industrial Standards Committee (JISC) class value for CP or alloyed materials:

TABLE 1

| | UTS | YS | EM | SM | | E | B | R |
|---|---|---|---|---|---|---|---|---|
| | ksi | ksi | ksi | ksi | PR | % | mm(T) | μΩ · cm |
| Ti Strip 1 (Gr. 1) | 48 | 35 | 14,900 | 6,500 | 0.35 | 30 | 1.5 T | 42 |
| Ti Strip 2 (Gr. 12) | 65 | 55 | 15,200 | 6,500 | 0.37 | 25 | 1.5 T | 52 |
| Ti Strip 3 (Gr. 17) | 40 | 30 | 15,000 | 5,500 | 0.32 | 24-27 | 1.5 T | 54 |
| Ti Strip 4 (Gr. 27) | 40 | 25 | 15,000 | 5,500 | 0.35 | 24-27 | 1.5 T | 54 |
| Ti Strip 5 (Cl. 1) | 55 | 35 | 15,300 | 5,750 | 0.35 | 27 | 1.5 T | 50 |
| Ti Strip 6 (Cl. 11) | 35 | 25 | 14,000 | 5,000 | 0.34 | 27 | 1.5 T | 48 |
| Ti Strip 7 (Cl. 21) | 50 | 35 | 15,000 | 5,750 | 0.33 | 24 | 1.5 T | 53 |

ASTM B265-11, the entirety of which is incorporated herein by reference in its entirety for all purposes, describes ASTM Test Method E290 in more detail. Test bends of example materials described herein were made in accordance with ASTM Test Method E290, using Method 1, Guided Bend Test, as described in paragraph 3.6, by bending the material through 105° and allowing the bent material to spring back naturally, such as described in ASTM B265-11, at section 6.3.

In some embodiments, the titanium-based strip 60 can be bent to form an exterior circumferential portion of a planar conductive portion (e.g., terminal or contact) of the housing or casing of the coin cell battery. In some embodiments, the exterior circumferential portion formed from the titanium-based strip 60 can be formed by bending a portion of the titanium-based strip 60 between about 90 degrees and about 270 degrees out of plane with a remainder of the planar conductive portion, such as when being joined with a side wall of the housing or when forming the terminal or contact from the titanium-based strip 60.

In some embodiments, a surface coating or layer can be applied onto a surface of or formed as an external surface of the titanium-based strip 60. For example, a surface coating or external surface of the titanium-based strip 60 can comprise one or more of: TIN, Ti₂N, or TiC. Without wishing to be bound by any particular theory, a surface coating such as described herein may reduce a contact resistance between the positive can surface formed from the coated titanium-based strip 60 and a device contact in which the coin cell battery is being used.

In some embodiments, when bent, the titanium-based strip 60 may have a bend radius without fracture relative to the thickness of the titanium-based strip of less than about 500%, less than about 200%, less than about 175%, less than about 150%, or less than about 125%, inclusive of all values and ranges therewithin and therebetween. For example, a titanium-based strip 60 with a thickness of 0.2 mm and a bend radius of 0.3 mm has a bend radius relative to the thickness of the titanium-based strip 60 of 150%.

In some embodiments, the titanium-based strip 60, once bent, did not experience any, or substantially any, cracking or micro-cracking at or about the bend.

In some embodiments, the titanium-based strip 60 can comprise a measurable amount of one or more of: nitrogen, carbon, hydrogen, iron, oxygen, aluminum, vanadium, tin, ruthenium, palladium, cobalt, molybdenum, chromium, nickel, niobium, zirconium, silicon, or titanium. Provided herein are example compositions for the titanium-based strip 60, in which all percentage (%) values are provided as “weight percent”, “wt. %”, “wt %”, or “wt %”, including where only “%” is used.

The titanium-based strip 60 can be formed into a portion of a housing or casing, such as a terminal or other conductive portion, a side wall, and/or an internal component of a coin cell battery. In some embodiments, the titanium-based strip 60 can comprise greater than about 95 wt % titanium, greater than about 96 wt. % titanium, greater than about 97 wt. % titanium, greater than about 98 wt. % titanium, greater than about 99 wt. % titanium, or greater than about 99.5 wt. % titanium, inclusive of all values and ranges therebetween and therewithin.

In some embodiments, the titanium-based strip 60 can comprise less than about 0.50 wt % iron, less than about 0.25 wt % iron, or less than about 0.10 wt % iron, inclusive of all values and ranges therebetween and therewithin.

In some embodiments, the titanium-based strip 60 can comprise less than about less than about 0.50 wt % oxygen, less than about 0.25 wt % oxygen, or less than about 0.10 wt % oxygen, inclusive of all values and ranges therebetween and therewithin.

In some embodiments, the titanium-based strip 60 can comprise less than about 0.25 wt % carbon, less than about 0.10 wt % carbon, or less than or equal to about 0.08 wt % carbon, inclusive of all values and ranges therebetween and therewithin.

In some embodiments, the titanium-based strip 60 can comprise less than about 0.10 wt % nitrogen, less than about 0.08 wt % nitrogen, less than about 0.06 wt % nitrogen, or less than about 0.04 wt % nitrogen, inclusive of all values and ranges therebetween and therewithin.

In some embodiments, the titanium-based strip 60 can comprise less than about 0.10 wt % hydrogen, less than about 0.05 wt % hydrogen, less than about 0.04 wt % hydrogen, less than about 0.03 wt % hydrogen, or less than about 0.02 wt % hydrogen, inclusive of all values and ranges therebetween and therewithin.

In some embodiments, the titanium-based strip 60 can comprise or consist essentially of: less than or equal to about 0.100% carbon, less than or equal to about 0.015% hydrogen, less than or equal to about 0.300% iron, less than or equal to about 0.030% nitrogen, less than or equal to about 0.25% oxygen, greater than or equal to about 99.00% titanium, less than or equal to about 0.400% molybdenum, less than or equal to about 0.25% palladium, less than or equal to about 0.50% niobium, less than or equal to about 0.05% aluminum, less than or equal to about 0.060% ruthenium, and less than or equal to about 0.060% nickel.

In some embodiments, the titanium-based strip 60 can comprise or consist essentially of: less than or equal to about 0.100% carbon, less than or equal to about 0.015% hydrogen, less than or equal to about 0.400% iron, less than or equal to about 0.030% nitrogen, less than or equal to about 0.17% oxygen, greater than or equal to about 81% titanium, less than or equal to about 16% molybdenum, less than or equal to about 3.2% niobium, less than or equal to about 3.5% aluminum, and less than or equal to about 0.40% residuals.

In some embodiments, the titanium-based strip 60 can comprise or consist essentially of: between about 0.080% and 0.100% carbon, between about 0.013% and 0.015% hydrogen, between about 0.200% and 0.300% iron, less than or equal to about 0.030% nitrogen, between about 0.100% and 0.25% oxygen, greater than or equal to about 99.00% titanium, between 0% and about 0.400% molybdenum, between 0% and about 0.25% palladium, between 0% and about 0.060% ruthenium, and between 0% and about 0.060% nickel.

In some embodiments, the titanium-based strip 60 can comprise or consist essentially of: less than or equal to about 0.10% carbon, less than or equal to about 0.015% hydrogen, less than or equal to about 0.20% iron, less than or equal to about 0.030% nitrogen, less than or equal to about 0.18% oxygen, greater than or equal to about 99.175% titanium, with the balance including other trace elements or contaminants. A titanium-based strip 60 having such a composition will have some or all of the desired physical characteristics, mechanical properties, electrical properties, and electrochemical properties described herein, such as a relatively high durability, a relatively high ductility, a relatively low resistivity, and relatively little or no electrolysis potential. A titanium-based strip 60 having such a composition can be formed into a terminal or contact (e.g., positive terminal can) for a coin cell battery (e.g., electrochemical coin cell 10), which may have a negative terminal cup formed from a different material.

In some embodiments, the titanium-based strip 60 can comprise or consist essentially of: less than or equal to about 0.08% carbon, less than or equal to about 0.015% hydrogen, less than or equal to about 0.20% iron, less than or equal to about 0.030% nitrogen, less than or equal to about 0.18% oxygen, less than or equal to about 0.25% palladium, with the balance comprising titanium. A titanium-based strip 60 having such a composition will have some or all of the desired physical characteristics, mechanical properties, electrical properties, and electrochemical properties described herein, such as a relatively high durability, a relatively high ductility, a relatively low resistivity, and relatively little or no electrolysis potential. A titanium-based strip 60 having such a composition can be formed into a terminal or contact (e.g., positive terminal can) for a coin cell battery (e.g., electrochemical coin cell 10), which may have a negative terminal cup formed from a different material.

In some embodiments, the titanium-based strip 60 can comprise or consist essentially of: less than or equal to about 0.080% carbon, less than or equal to about 0.015% hydrogen, less than or equal to about 0.30% iron, between about 0.20% and about 0.40% molybdenum, between about 0.60% and about 0.90% nickel, less than or equal to about 0.030% nitrogen, less than or equal to about 0.25% oxygen, between about 97.725% and about 99.20% titanium, with the balance including other trace elements or contaminants. A titanium-based strip 60 having such a composition will have some or all of the desired physical characteristics, mechanical properties, electrical properties, and electrochemical properties described herein, such as a relatively high durability, a relatively high ductility, a relatively low resistivity, and relatively little or no electrolysis potential. A titanium-based strip 60 having such a composition can be formed into a terminal or contact (e.g., positive terminal can) for a coin cell battery (e.g., electrochemical coin cell 10), which may have a negative terminal cup formed from a different material.

In some embodiments, the titanium-based strip 60 can comprise or consist essentially of: less than or equal to about 0.080% carbon, less than or equal to about 0.015% hydrogen, less than or equal to about 0.20% iron, less than or equal to about 0.030% nitrogen, less than or equal to about 0.18% oxygen, greater than or equal to about 99.175% titanium, with the balance including other trace elements or contaminants. A titanium-based strip 60 having such a composition will have some or all of the desired physical characteristics, mechanical properties, electrical properties, and electrochemical properties described herein, such as a relatively high durability, a relatively high ductility, a relatively low resistivity, and relatively little or no electrolysis potential. A titanium-based strip 60 having such a composition can be formed into a terminal or contact (e.g., positive terminal can) for a coin cell battery (e.g., electrochemical coin cell 10), which may have a negative terminal cup formed from a different material.

In some embodiments, the titanium-based strip 60 can comprise or consist essentially of: less than or equal to about 0.10% carbon, less than or equal to about 0.015% hydrogen, less than or equal to about 0.20% iron, less than or equal to about 0.030% nitrogen, less than or equal to about 0.18% oxygen, between about 99.00% and about 99.92% titanium, with the balance including other trace elements or contaminants. A titanium-based strip 60 having such a composition will have some or all of the desired physical characteristics, mechanical properties, electrical properties, and electrochemical properties described herein, such as a relatively high durability, a relatively high ductility, a relatively low resistivity, and relatively little or no electrolysis potential. A titanium-based strip 60 having such a composition can be formed into a terminal or contact (e.g., positive terminal can) for a coin cell battery (e.g., electrochemical coin cell 10), which may have a negative terminal cup formed from a different material.

In some embodiments, the titanium-based strip 60 can comprise or consist essentially of: less than or equal to about 0.080% carbon, less than or equal to about 0.013% hydrogen, less than or equal to about 0.20% iron, less than or equal to about 0.030% nitrogen, less than or equal to about 0.15% oxygen, with the balance comprising or consisting essentially of titanium. A titanium-based strip 60 having such a composition will have some or all of the desired physical characteristics, mechanical properties, electrical properties, and electrochemical properties described herein, such as a relatively high durability, a relatively high ductility, a relatively low resistivity, and relatively little or no electrolysis potential. A titanium-based strip 60 having such a composition can be formed into a terminal or contact (e.g., positive terminal can) for a coin cell battery (e.g., electrochemical coin cell 10), which may have a negative terminal cup formed from a different material.

In some embodiments, the titanium-based strip 60 can comprise or consist essentially of: less than or equal to about 0.080% carbon, less than or equal to about 0.013% hydrogen, less than or equal to about 0.20% iron, less than or equal to about 0.030% nitrogen, less than or equal to about 0.18% oxygen, between about 0.12% and about 0.25% palladium, with the balance comprising or consisting essentially of titanium. A titanium-based strip 60 having such a composition will have some or all of the desired physical characteristics, mechanical properties, electrical properties, and electrochemical properties described herein, such as a relatively high durability, a relatively high ductility, a relatively low resistivity, and relatively little or no electrolysis potential. A titanium-based strip 60 having such a composition can be formed into a terminal or contact (e.g., positive terminal can) for a coin cell battery (e.g., electrochemical coin cell 10), which may have a negative terminal cup formed from a different material.

In some embodiments, the titanium-based strip 60 can comprise or consist essentially of: less than or equal to about 0.080% carbon, less than or equal to about 0.015% hydrogen, less than or equal to about 0.20% iron, less than or equal to about 0.030% nitrogen, less than or equal to about 0.10% oxygen, between about 0.04% and about 0.06% ruthenium, between about 0.04% and about 0.06% nickel, with the balance comprising or consisting essentially of titanium. A titanium-based strip (e.g., the titanium-based strip 60) having such a composition will have some or all of the desired physical characteristics, mechanical properties, electrical properties, and electrochemical properties described herein, such as a relatively high durability, a relatively high ductility, a relatively low resistivity, and relatively little or no electrolysis potential. A titanium-based strip (e.g., the titanium-based strip 60) having such a composition can be formed into a terminal or contact (e.g., positive terminal can) for a coin cell battery (e.g., electrochemical coin cell 10), which may have a negative terminal cup formed from a different material.

Provided below in Table 2 are several example titanium-based strips (e.g., titanium-based strip 60) that correspond to the titanium-based strips associated with the mechanical properties listed in Table 1. In Table 2, the composition of each of these titanium-based strips (e.g., titanium-based strip 60) is provided.

TABLE 2

| | C | H | Fe | N | O | Mo | Nb | Al | Si | Ru | Pd | Ni | Ti |
|---|---|---|---|---|---|---|---|---|---|---|---|---|---|
| | % | % | % | % | % | % | % | % | % | % | % | % | % |
| Ti Strip 1 | .08 | .015 | .2 | .03 | .18 | — | — | — | — | — | — | — | Bal. |
| Gr. 1 | | | | | | | | | | | | | |
| Ti Strip 2 | .08 | .015 | .2 | .03 | .18 | — | — | — | — | — | 0.18 | . | Bal. |
| Gr. 11 | | | | | | | | | | | | | |
| Ti Strip 3 | .08 | .015 | .2 | .03 | .18 | — | — | — | — | — | .06 | — | Bal. |
| Gr. 17 | | | | | | | | | | | | | |
| Ti Strip 4 | .08 | .015 | .2 | .03 | .18 | — | | | | — | — | — | Bal. |
| Gr. 27 | | | | | | | | | | | | | |
| Ti Strip 5 | .08 | .013 | .2 | .03 | .15 | — | — | — | — | — | — | — | Bal. |
| Cl. 1 | | | | | | | | | | | | | |
| Ti Strip 6 | .08 | .013 | .2 | .03 | .15 | — | — | — | — | — | .2 | — | Bal. |
| Cl. 11 | | | | | | | | | | | | | |
| Ti Strip 7 | .08 | .015 | .2 | .03 | .1 | — | — | — | — | .05 | — | .05 | Bal. |
| Cl. 21 | | | | | | | | | | | | | |

Described below are several non-limiting examples of titanium-containing or titanium-based can materials used for positive can formation for coin cells. Table 3 provides an overview of several of the myriad examples, including a comparison of the construction and compositional differences against a comparative example, at a high level.

TABLE 3

| | Comparative | | | |
|---|---|---|---|---|
| | Example | Example 1 | Example 2 | Example 3 |
| Battery case | Positive can | Positive can | Positive can | Positive can |
| Construction | tri-clad | Single-layer Ti | 2-layer construction: TiN | 3 layer |
| | (Ni/Ti/SS) | construction | and Ti₂N or TiC (<1 um) | construction |
| | | with designated | for the top layer and Ti | |
| | | mechanical | substrate with designated | |
| | | properties | mechanical properties | |
| | | (100-300 um) | (100-300 um) | |
| Top Surface | Ni | — | — | Ni (<1 um or |
| layer | (0.5-10 um) | | | preferably <0.5 |
| | | | | um) |
| Intermediate | Ti | — | — | Ti with |
| layer | (3-50 um) | | | designated |
| | | | | mechanical |
| | | | | properties |
| | | | | (100-300 um) |
| Substrate | SS (100- | — | — | Ni (<1 um or |
| | 300 um) | | | preferably <0.5 |
| | | | | um) |

### Example 1

A titanium-based strip (e.g., titanium-based strip 60) was formed that had a thickness of about 0.2 mm to about 0.3 mm. The composition of the titanium-based strip was about 0.10% carbon, about 0.015% hydrogen, about 0.20% iron, about 0.030% nitrogen, about 0.18% oxygen, and about 99.175% titanium, with the balance including other trace elements or contaminants that did not materially affect the mechanical properties (e.g., cold formability) of the titanium-based strip. The titanium-based strip (e.g., titanium-based strip 60) was tested (e.g., according to ASTM B265-20a) and determined to have an elongation at break of about 27% of the length of the titanium-based strip. A bend having a bend radius of about 1.5 times the thickness of the titanium-based strip was formed in the titanium-based strip using mechanical stress at about room temperature (e.g., about 21° C.) according to, e.g., ASTM E290 using method 1. The titanium-based strip (e.g., titanium-based strip 60), once bent, did not experience any, or did not experience substantially any, cracking or micro-cracking at or about the bend, either inside or outside at the apex of the bend, or along the setbacks from the bend.

### Example 2

A titanium-based strip (e.g., titanium-based strip 60) was formed that had a thickness of about 0.2 mm to about 0.3 mm. The composition of the titanium-based strip was about 0.10% carbon, about 0.015% hydrogen, about 0.20% iron, about 0.030% nitrogen, about 0.18% oxygen, and about 99.175% titanium, with the balance including other trace elements or contaminants that did not materially affect the mechanical properties (e.g., cold formability) of the titanium-based strip. The titanium-based strip (e.g., titanium-based strip 60) was at least partially covered or coated with a material comprising one or more of: TIN, Ti₂N, or TiC on a surface of the titanium-based strip, the surface being chosen based upon the particular bend procedures such that the bent titanium-based strip could be otherwise configured and dimensioned to face an outside of a terminal or contact of the coin cell battery, so as to further reduce or eliminate contact resistance between, e.g., the positive terminal or contact of the coin cell battery and a corresponding contact of the device into which the coin cell battery is configured to be disposed or otherwise placed in electrical communication.

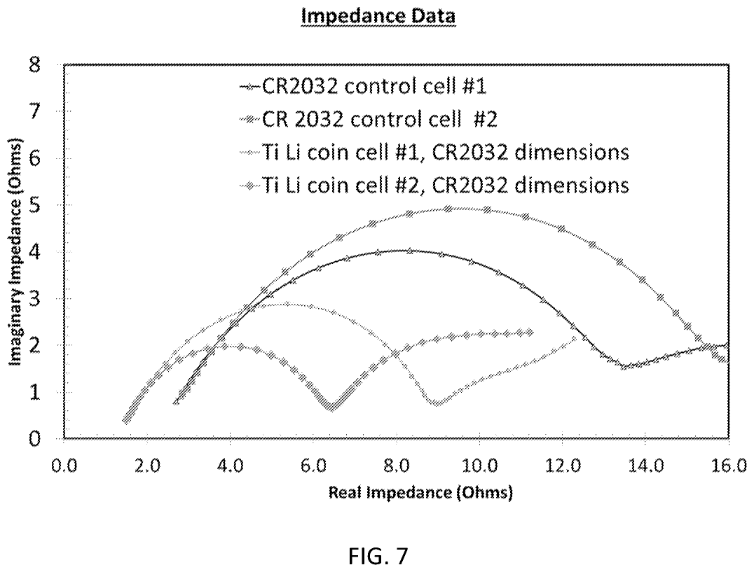

Impedance spectra of the coin cells were recorded via electrochemical impedance spectroscopy (EIS) using a Solartron frequency response analyzer (FRA), model: SI 1250 (Solartron Metrology, West Sussex, UK) controlled by a Solartron potentiostat instrument, model: SI 1286 (Solartron Metrology, West Sussex, UK). A small voltage amplitude of 10 mV was applied to the voltage leads and the responding current was measured (a 4-point probe configuration). The frequency scans started from 65,000 down to 1 Hz and the data was collected using Zplot, ver. 2.4. The internal resistance was the intercept of the impedance spectrum with the real spectrum at high frequency by fitting the impedance semi-circle, as shown in FIG. 7.

As mentioned above, the resistivity of the titanium-based strip (e.g., titanium-based strip 60) for positive can construction was measured using a four-point collinear probe. Table 4 compares the resistivity of a titanium-based strip (e.g., titanium-based strip 60) with a conventional stainless steel-based strip used for conventional coin cell construction.

TABLE 4

| | Resistivity at room temperature |
|---|---|
| Material | (μΩ · cm) |
| Titanium-based strip (e.g., 60) | 54 |
| SS430-based strip | 60 |

As shown, titanium-based strips (e.g., titanium-based strip 60) have a lower resistivity than the SS430-based strips. Thus, the titanium-based strip is more well-suited as a positive can/terminal/contact material as it does not cause electrical problems with regard to discharge, while still providing for reduced or eliminated incidence of alkalizing reactions/electrolysis reactions in the eventual coin cell battery, when placed in contact with bodily fluids such as saliva.

Also, while titanium is often prone to oxidation, the titanium-based strip (e.g., titanium-based strip 60), especially when coated as discussed herein, reduced or prevented oxidation and associated corrosion of the titanium-based terminal/can housing relative to a conventional CR2023 coin cell battery. However, the formed TiOₓ (where x=1 to 2) oxide layer is very thin under normal usage and storage. This thin layer has the benefit of preventing further corrosion of the Ti material. Thus, titanium is more corrosion-resistant than nickel or stainless steel in such applications. Also, the thin TiOₓ layer does not affect or materially affect the cell resistance, as shown below in Table 5.

TABLE 5

| | Cell OCV (V) and internal resistance (Ohms) | | |
|---|---|---|---|
| | | Cell #1 | Cell #2 |
| CR2023 | OCV (V) | 3.290 | 3.290 |
| (SS430 with | Internal resistance (ohms) | 2.38 | 2.40 |
| Ni plating for | | | |
| positive) | | | |
| CR2023 | OCV (V) | 3.310 | 3.310 |
| (titanium- | Internal resistance (ohms) | 1.48 | 1.37 |
| based positive | | | |
| can) | | | |

Without wishing to be bound by any particular theory, the thin TiOₓ layer that forms on an external surface of the can/terminal may not affect or materially affect the cell resistance, as shown in Table 5, due to an electron tunneling effect.

### Example 3

A titanium-based strip (e.g., titanium-based strip 60) was formed, that had a thickness of about 0.2 mm to about 0.3 mm. The composition of the titanium-based strip was about 0.080% carbon, about 0.013% hydrogen, about 0.30% iron, about 0.030% nitrogen, about 0.25% oxygen, between about 0.20% and about 0.40% molybdenum, between about 0.60% and about 0.90% nickel, and between about 97.725% and about 99.20% titanium, with the balance including other trace elements or contaminants that did not materially affect the mechanical properties (e.g., cold formability) of the titanium-based strip.

The titanium-based strip (e.g., titanium-based strip 60) was at least partially covered or coated with a material comprising or consisting of nickel on one or more surfaces of the titanium-based strip. In some preferred embodiments, a very thin layer of nickel is formed on both surfaces of the titanium-based strip. The nickel layer on the titanium-based strip can face an outside of a terminal or contact (e.g., positive terminal) of the coin cell battery, so as to further reduce or eliminate contact resistance between a terminal, e.g., the positive terminal or contact, of the coin cell battery and a corresponding contact of the device into which the coin cell battery is configured to be disposed or otherwise placed in electrical communication. This layer of nickel can reduce the resistance between the positive can/contact and the corresponding contact of the device using the coin cell battery. When both sides of the titanium-based strip were plated or coated, at least partially, with thin layers of nickel, they were found to reduce resistance between the positive can/terminal and the corresponding contact of the device using the coin cell battery, and it was further found that the resistance was reduced between the positive can/terminal and the cathode inside the coin cell battery.

Often, titanium-based strips (e.g., titanium-based strip 60) are annealed during production. Because titanium is prone to oxidation in air and forms TiOₓ oxides (x=1 to 2), especially when x=2, the oxidized titanium-based strip can often not be very conductive and the contact resistance could be high if the thickness of the TiO₂ layer is too great. Therefore, it was found that disposing a nickel-based coating comprising one or more of: TIN, Ti₂N, and/or TiC, on one or both surfaces of the titanium-based strip during the annealing step results in less oxidation and a thinner oxidation layer of TiOₓ, which reduces contact resistance of the finished/formed positive can/terminal. The formed layer of TiN, Ti₂N, and/or TiC on the surface(s) of the titanium-based strip may reduce the contact resistance due to the lower resistivity of these materials. In some embodiments, this nickel-based coating can be applied by annealing the titanium-based strips (e.g., a cold-rolled titanium-based sheet) under a nitrogen gas atmosphere for the formation of TiN and Ti₂N or an argon gas atmosphere for the formation of TiC on the surface(s) of the titanium-based strips. The formed TiN and Ti₂N or TiC structure can be continuous or discontinuous on the surface(s) of the titanium-based strips/sheets.

In terms of thickness, a thin nickel-based layer (e.g., <1 μm, and preferably <0.5 μm) can be used. The nickel-based layer can be applied, plated, or otherwise disposed onto the titanium-based strip/sheet/foil (e.g., titanium-based strip 60) via any suitable manner or means. For example, a titanium-based strip can be cleaned and a nickel-based coating can be applied or otherwise plated onto the surface(s) of the titanium-based strip using an electrolytic process or an electroless deposition plating technique, among other contemplated approaches. The nickel-based coating/plating was disposed on one or both sides of the titanium surfaces of the titanium-based strip/sheet/foil.

Referring now to FIG. 8, a method 70 is illustrated that can be carried out by any suitable means. The method 70 can comprise: forming a sheet comprising greater than about 97 wt. % titanium, at 71. The method 70 can further comprise: forming the sheet into a terminal for an electrochemical coin cell, at 72. The method 70 can, optionally, further comprise: sealing active electrochemical components within an inner volume of the electrochemical coin cell by joining a circumferential edge of the terminal to one or more portions of a cylindrical housing cup such that the contact is in electrical communication with the active electrochemical components of the coin cell battery, at 73.

In some embodiments, the active electrochemical components in the inner volume of the electrochemical coin cell can comprise an anode, a separator, and a cathode. In some embodiments, the active electrochemical components are configured to produce an output open circuit voltage of at least 2.8 volts in the presence of a non-aqueous electrolyte.

In some embodiments, the terminal (e.g., formed from a titanium-based sheet 60) is dimensioned and configured to be resistant to reactions producing hydroxides during exposure to human bodily fluids.

In some embodiments, the sheet (e.g., titanium-based strip 60) comprises less than about 0.5 wt. % iron, less than about 0.5 wt. % oxygen, less than about 0.5 wt. % carbon, less than about 0.5 wt. % nitrogen, and less than about 0.5 wt % hydrogen. In some embodiments, the sheet comprises less than about 0.3 wt. % iron, less than about 0.25 wt. % oxygen, less than about 0.1 wt. % carbon, less than about 0.03 wt. % nitrogen, and less than about 0.015 wt. % hydrogen.

In some embodiments, the sheet (e.g., titanium-based strip 60) has an ultimate tensile strength of between about 40,000 psi and about 60,000 psi. In some embodiments, the sheet (e.g., titanium-based strip 60) has a breaking elongation of between about 10% and about 50%. In some embodiments, the sheet (e.g., titanium-based strip 60) has an elastic modulus of between about 10,000 ksi and about 20,000 ksi. In some embodiments, the sheet (e.g., titanium-based strip 60) has a compressive modulus of between about 10,000 ksi and about 20,000 ksi. In some embodiments, the sheet (e.g., titanium-based strip 60) has a shear modulus of between about 4,000 ksi and about 10,000 ksi. In some embodiments, the sheet (e.g., titanium-based strip 60) has a Poisson's ratio of between about 0.25 and about 0.40. In some embodiments, the sheet (e.g., titanium-based strip 60) has an annealed fracture toughness of between about 50 ksi-in^{1/2} and about 65 ksi-in^{1/2}. In some embodiments, the sheet (e.g., titanium-based strip 60) has an electrical resistivity of between about 40μΩ·cm and about 100μΩ·cm.

In some embodiments, the sheet (e.g., titanium-based strip 60) has an ultimate tensile strength of between about 40,000 psi and about 60,000 psi, a breaking elongation of between about 10% and about 50%, an elastic modulus of between about 10,000 ksi and about 20,000 ksi, a compressive modulus of between about 10,000 ksi and about 20,000 ksi, a shear modulus of between about 4,000 ksi and about 10,000 ksi, a Poisson's ratio of between about 0.25 and about 0.40, an annealed fracture toughness of between about 50 ksi-in^{1/2} and about 65 ksi-in^{1/2}, and an electrical resistivity of between about 40 μΩ·cm and about 100μΩ·cm.

In some embodiments, the method can further comprise annealing the sheet (e.g., titanium-based strip 60) prior to formation of the terminal. In some embodiments, the method can further comprise coating a portion or all of the sheet with a nickel-containing surface coating.

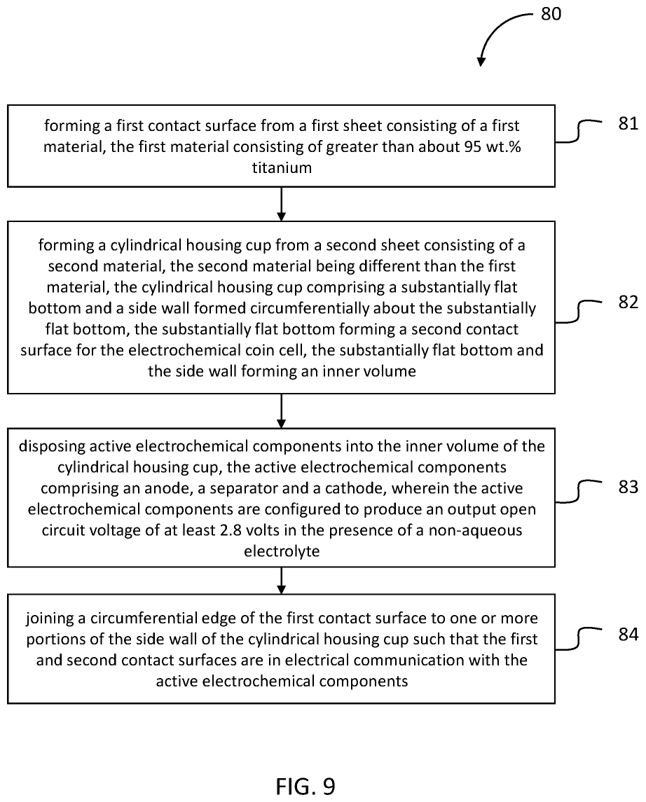

Referring now to FIG. 9, a method 80 is illustrated that can be carried out by any suitable means. The method 80 can comprise: forming a first contact surface from a first sheet consisting of a first material, the first material consisting of greater than about 95 wt. % titanium, at 81. The method 80 can further comprise: forming a cylindrical housing cup from a second sheet consisting of a second material, the second material being different than the first material, the cylindrical housing cup comprising a substantially flat bottom and a side wall formed circumferentially about the substantially flat bottom, the substantially flat bottom forming a second contact surface for the electrochemical coin cell, the substantially flat bottom and the side wall forming an inner volume, at 82. In some embodiments, the second material comprises stainless steel. The method 80 can further comprise: disposing active electrochemical components into the inner volume of the cylindrical housing cup, the active electrochemical components comprising an anode, a separator and a cathode, wherein the active electrochemical components are configured to produce an output open circuit voltage of at least 2.8 volts in the presence of a non-aqueous electrolyte, at 83. The method 80 can further comprise: joining a circumferential edge of the first contact surface to one or more portions of the side wall of the cylindrical housing cup such that the first and second contact surfaces are in electrical communication with the active electrochemical components, at 84.

In some embodiments, the active electrochemical components in the inner volume of the electrochemical coin cell can comprise an anode, a separator, and a cathode. In some embodiments, the active electrochemical components are configured to produce an output open circuit voltage of at least 2.8 volts in the presence of a non-aqueous electrolyte.

In some embodiments, the first contact surface can be dimensioned and configured to be resistant to reactions producing hydroxides during exposure to human bodily fluids.

In some embodiments, the first material comprises less than about 0.5 wt. % iron, less than about 0.5 wt. % oxygen, less than about 0.5 wt. % carbon, less than about 0.5 wt. % nitrogen, and less than about 0.5 wt % hydrogen, with the balance or substantially all of the balance of the composition being titanium. In some embodiments, the first material comprises less than about 0.3 wt. % iron, less than about 0.25 wt. % oxygen, less than about 0.1 wt. % carbon, less than about 0.03 wt. % nitrogen, and less than about 0.015 wt. % hydrogen, with the balance or substantially all of the balance of the composition being titanium.

In some embodiments, the first material has an ultimate tensile strength of between about 40,000 psi and about 60,000 psi. In some embodiments, the first material has a breaking elongation of between about 10% and about 50%. In some embodiments, the first material has an clastic modulus of between about 10,000 ksi and about 20,000 ksi. In some embodiments, the first material has a compressive modulus of between about 10,000 ksi and about 20,000 ksi. In some embodiments, the first material has a shear modulus of between about 4,000 ksi and about 10,000 ksi. In some embodiments, the first material has a Poisson's ratio of between about 0.25 and about 0.40. In some embodiments, the first material has an annealed fracture toughness of between about 50 ksi-in^{1/2} and about 65 ksi-in^{1/2}. In some embodiments, the first material has an electrical resistivity of between about 40μΩ·cm and about 100μΩ·cm.

In some embodiments, the method can further comprise coating a portion or all of the first material with a nickel-containing surface coating. In some embodiments, said coating at least a portion of the first material is carried out by annealing the sheet of the first material. In some embodiments, the sheet of the first material can be annealed in an argon-rich or nitrogen-rich atmosphere. In some embodiments, the annealing of the sheet of the first material can be carried out prior to formation of a contact, terminal, or other portion of the coin cell using the first sheet of the first material.

As shown in Table 1, various of the contemplated compositions for a sheet (e.g., titanium-based strip 60) composed of a material (e.g., the first material) that is resistant to alkalizing reactions, such as the electrolysis formation reactions described above with regard to FIG. 1, can have all or some of these mechanical properties, physical characteristics, and electrical properties.

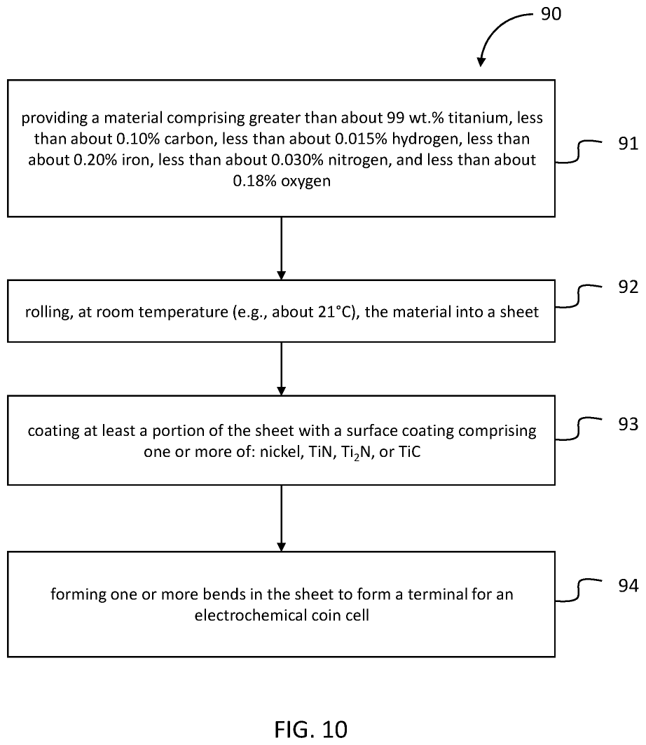

Referring now to FIG. 10, a method 90 is illustrated that can be carried out by any suitable means. The method 90 can comprise: providing a material comprising greater than about 99 wt. % titanium, less than about 0.10% carbon, less than about 0.015% hydrogen, less than about 0.20% iron, less than about 0.030% nitrogen, and less than about 0.18% oxygen, at 91. The method 90 can further comprise: rolling, at room temperature (e.g., about 21° C.), the material into a sheet, at 92. The method 90 can further comprise: coating at least a portion of the sheet with a surface coating comprising one or more of: nickel, TiN, Ti₂N, or TiC, at 93. The method 90 can further comprise: forming one or more bends in the sheet to form a terminal for an electrochemical coin cell, at 94.

In some embodiments, said coating at least a portion of the sheet is carried out by annealing the sheet. In some embodiments, the sheet can be annealed in an argon-rich or nitrogen-rich atmosphere.

In some embodiments, the method can further comprise forming a housing or casing for the electrochemical coin cell that has an inner volume configured to contain active electrochemical components. The active electrochemical components can comprise an anode, a separator, and a cathode. In some embodiments, the active electrochemical components are configured to produce an output open circuit voltage of at least 2.8 volts in the presence of a non-aqueous electrolyte. To form the electrochemical coin cell, the terminal can be sealed to one or more side walls of the housing or casing.

In some embodiments, the material and/or the terminal is/are dimensioned and configured to be resistant to reactions producing hydroxides during exposure to human bodily fluids.

In some embodiments, the material comprises less than about 0.5 wt. % iron, less than about 0.5 wt. % oxygen, less than about 0.5 wt. % carbon, less than about 0.5 wt. % nitrogen, and less than about 0.5 wt % hydrogen. In some embodiments, the material comprises less than about 0.3 wt. % iron, less than about 0.25 wt. % oxygen, less than about 0.1 wt. % carbon, less than about 0.03 wt. % nitrogen, and less than about 0.015 wt. % hydrogen.

In some embodiments, the material has an ultimate tensile strength of between about 40,000 psi and about 60,000 psi. In some embodiments, the material has a breaking elongation of between about 10% and about 50%. In some embodiments, the material has an elastic modulus of between about 10,000 ksi and about 20,000 ksi. In some embodiments, the material has a compressive modulus of between about 10,000 ksi and about 20,000 ksi. In some embodiments, the material has a shear modulus of between about 4,000 ksi and about 10,000 ksi. In some embodiments, the material has a Poisson's ratio of between about 0.25 and about 0.40. In some embodiments, the material has an annealed fracture toughness of between about 50 ksi-in^{1/2} and about 65 ksi-in^{1/2}. In some embodiments, the material has an electrical resistivity of between about 10μΩ·cm and about 100μΩ·cm.

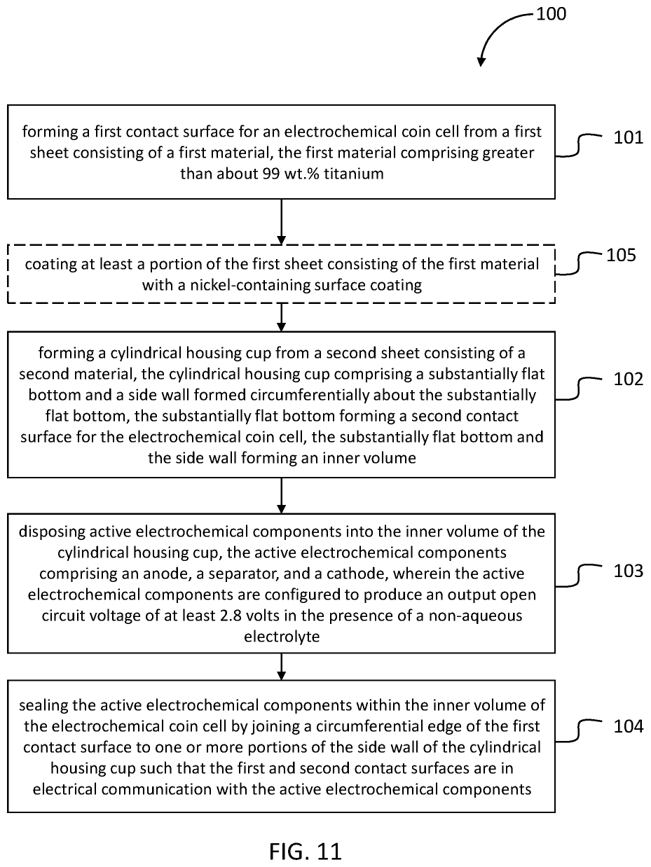

Referring now to FIG. 11, a method 100 is illustrated that can be carried out by any suitable means. The method 100 can comprise: forming a first contact surface for an electrochemical coin cell from a first sheet consisting of a first material, the first material comprising greater than about 99 wt. % titanium, at 101. The method 100 can further comprise: forming a cylindrical housing cup from a second sheet consisting of a second material, the cylindrical housing cup comprising a substantially flat bottom and a side wall formed circumferentially about the substantially flat bottom, the substantially flat bottom forming a second contact surface for the electrochemical coin cell, the substantially flat bottom and the side wall forming an inner volume, at 102. The method 100 can further comprise: disposing active electrochemical components into the inner volume of the cylindrical housing cup, the active electrochemical components comprising an anode, a separator, and a cathode, wherein the active electrochemical components are configured to produce an output open circuit voltage of at least 2.8 volts in the presence of a non-aqueous electrolyte, at 103. The method 100 can further comprise: sealing the active electrochemical components within the inner volume of the electrochemical coin cell by joining a circumferential edge of the first contact surface to one or more portions of the side wall of the cylindrical housing cup such that the first and second contact surfaces are in electrical communication with the active electrochemical components, at 104.

In some embodiments, the circumferential edge of the first contact surface is joined to the one or more portions of the side wall of the cylindrical housing cup by bending or crimping one or more of the circumferential edge of the first contact surface or the one or more portions of the side wall of the cylindrical housing cup.

In some embodiments, the first contact surface is dimensioned and configured to be resistant to reactions producing hydroxides during exposure to human bodily fluids.

In some embodiments, the first material comprises less than about 0.5 wt. % iron, less than about 0.5 wt. % oxygen, less than about 0.5 wt. % carbon, less than about 0.5 wt. % nitrogen, and less than about 0.5 wt % hydrogen, with a balance or substantially all of the balance of the composition being titanium. In some embodiments, the first material comprises less than about 0.3 wt. % iron, less than about 0.25 wt. % oxygen, less than about 0.1 wt. % carbon, less than about 0.03 wt. % nitrogen, and less than about 0.015 wt. % hydrogen, with a balance or substantially all of the balance of the composition being titanium.

In some embodiments, the first material has an ultimate tensile strength of between about 40,000 psi and about 60,000 psi. In some embodiments, the first material has a breaking elongation of between about 10% and about 50%. In some embodiments, the first material has an clastic modulus of between about 10,000 ksi and about 20,000 ksi. In some embodiments, the first material has a compressive modulus of between about 10,000 ksi and about 20,000 ksi. In some embodiments, the first material has a shear modulus of between about 4,000 ksi and about 10,000 ksi. In some embodiments, the first material has a Poisson's ratio of between about 0.25 and about 0.40. In some embodiments, the first material has an annealed fracture toughness of between about 50 ksi-in^{1/2} and about 65 ksi-in^{1/2}. In some embodiments, the first material has an electrical resistivity of between about 40μΩ·cm and about 100μΩ·cm.

In some embodiments, the method 100 can, optionally, further comprise coating at least a portion of the first sheet consisting of the first material with a nickel-containing surface coating, at 105. In some embodiments, said coating at least a portion of the first sheet consisting of the first material can be carried out by annealing the first sheet of the first material. In some embodiments, the first sheet can be annealed in an argon-rich or nitrogen-rich atmosphere. In some embodiments, the annealing of the first sheet of the first material can be carried out prior to formation of the first contact from the first sheet consisting of the first material.

Various embodiments are directed to coin cell batteries, and in particular to coin cell batteries including titanium-based contact materials with improved cold formability for safer coin cell batteries.

According to an embodiment, a casing is provided, the casing being configured for use in an electrochemical coin cell, the casing comprising: a housing having a flat wall and a side wall extending from one or more edges of the flat wall of the housing to form a housing can; and a planar conductive portion joined to the side wall of the housing to form an inner cavity configured to hold active components of the electrochemical coin cell, wherein the housing or the planar conductive portion comprise greater than about 95 wt. % titanium, and wherein a bend radius between the flat wall and the side wall of the housing is between about 100% and about 200% of a thickness of the one or more of the housing or the planar conductive portion.

In some embodiments, the housing or the planar conductive portion comprises greater than about 99 wt. % titanium. In some embodiments, the housing or the planar conductive portion comprises less than about 0.5 wt. % iron, less than about 0.5 wt. % oxygen, less than about 0.5 wt. % carbon, less than about 0.5 wt. % nitrogen, and less than about 0.5 wt % hydrogen. In some embodiments, the housing or the planar conductive portion comprises about 0.3 wt. % iron, about 0.25 wt. % oxygen, about 0.1 wt. % carbon, about 0.03 wt. % nitrogen, and about 0.015 wt. % hydrogen. In some embodiments, the housing or the planar conductive portion has an ultimate tensile strength of between about 40,000 psi and about 60,000 psi. In some embodiments, the housing or the planar conductive portion has a breaking elongation of between about 10% and about 50%. In some embodiments, the housing or the planar conductive portion has an elastic modulus of between about 10,000 ksi and about 20,000 ksi. In some embodiments, the housing or the planar conductive portion has a compressive modulus of between about 10,000 ksi and about 20,000 ksi. In some embodiments, the housing or the planar conductive portion has a shear modulus of between about 4,000 ksi and about 10,000 ksi. In some embodiments, the housing or the planar conductive portion has a Poisson's ratio of between about 0.25 and about 0.40. In some embodiments, the housing or the planar conductive portion has an annealed fracture toughness of between about 50 ksi-in^{1/2} and about 65 ksi-in^{1/2}. In some embodiments, the housing or the planar conductive portion has an elongation of greater than about 20% (e.g., between about 20% and about 50%) at room temperature (e.g., about 21° C.). In some embodiments, the housing or the planar conductive portion has an electrical resistivity of between about 40 μΩ·cm and about 100 μΩ·cm.

In some embodiments, an exterior circumferential portion of the planar conductive portion is bent between about 90 degrees and about 160 degrees out of plane with a remainder of the planar conductive portion when being joined with the side wall of the housing. In some embodiments, one or more of the housing or the planar conductive portion comprises a surface portion comprising one or more of: TiN, Ti₂N, or TiC. In some embodiments, one or more of the housing or the planar conductive portion comprises a surface coating comprising nickel. In some embodiments, the housing or the planar conductive portion comprises a material that is resistant to reactions that cause hydroxide formation.

According to another embodiment, an electrochemical coin cell can be provided that comprises: a cylindrical casing comprising a positive contact surface and a side wall formed circumferentially about the positive contact surface, wherein the cylindrical casing defines an inner volume; an anode material disposed within a first portion of the inner volume; a cathode material disposed within a second portion of the inner volume; a separator disposed within the inner volume between the anode material and the cathode material; an electrolyte material disposed within the inner volume and configured to communicate ions between the anode material and the cathode material; and a planar negative contact surface, wherein the positive contact surface comprises a titanium-containing material, and the planar negative contact surface being disposed within or adjacent to the inner volume such that the anode material, the cathode material, the separator, and the electrolyte material are enclosed within the inner volume, wherein a portion of the side wall is joined to an edge of the planar negative contact surface to seal the inner volume of the cylindrical casing. In some embodiments, a thickness of the planar negative contact surface is between about 0.1 mm and about 0.5 mm. In some embodiments, a bend radius at the edge of the planar negative contact surface relative to the side wall of the cylindrical casing is between about 1 mm and about 5 mm.

In some embodiments, the titanium-containing material comprises greater than about 95 wt. % titanium. In some embodiments, the titanium-containing material comprises greater than about 99 wt. % titanium. In some embodiments, the titanium-containing material comprises less than about 0.5 wt. % iron, less than about 0.5 wt. % oxygen, less than about 0.5 wt. % carbon, less than about 0.5 wt. % nitrogen, and less than about 0.5 wt % hydrogen. In some embodiments, the titanium-containing material comprises about 0.3 wt. % iron, about 0.25 wt. % oxygen, about 0.1 wt. % carbon, about 0.03 wt. % nitrogen, and about 0.015 wt. % hydrogen.

In some embodiments, the titanium-containing material has an ultimate tensile strength of between about 40,000 psi and about 60,000 psi. In some embodiments, the titanium-containing material has a breaking elongation of between about 10% and about 50%. In some embodiments, the titanium-containing material has an elastic modulus of between about 10,000 ksi and about 20,000 ksi. In some embodiments, the titanium-containing material has a compressive modulus of between about 10,000 ksi and about 20,000 ksi. In some embodiments, the titanium-containing material has a shear modulus of between about 4,000 ksi and about 10,000 ksi. In some embodiments, the titanium-containing material has a Poisson's ratio of between about 0.25 and about 0.40. In some embodiments, the titanium-containing material has an annealed fracture toughness of between about 50 ksi-in^{1/2} and about 65 ksi-in^{1/2}. In some embodiments, the titanium-containing material has an electrical resistivity of between about 40μΩ·cm and about 100μΩ·cm.

In some embodiments, the positive contact surface comprising the titanium-containing material is dimensioned and configured to be resistant to reactions that cause hydroxide formation.

In some embodiments, after bending of the edge of the planar negative contact surface and joining of the negative contact surface to the portion of the side wall of the cylindrical casing to seal the coin cell, when an outside surface of the planar negative contact surface of the electrochemical coin cell is exposed to human bodily fluids, substantially no hydroxides are formed during the subsequent about 480 minutes.

According to another embodiment, an electrochemical coin cell can be provided that comprises: active electrochemical components comprising an anode, a separator and a cathode, wherein the active electrochemical components produce an output open circuit voltage of at least 2.8 volts in the presence of a non-aqueous electrolyte; and a cylindrical container enclosing the active components, the cylindrical container comprising an anode terminal casing and a cathode terminal casing with an electrically insulating gasket disposed therebetween, the anode terminal casing being in electrical communication with the anode and the cathode terminal casing being in electrical communication with the cathode. In some embodiments, the cathode terminal casing consists of a first material that comprises greater than about 95 wt. % titanium, or greater than about 99 wt. % titanium. In some embodiments, a circumferential edge portion of the anode terminal casing is bent or crimped to join the anode terminal casing to the cylindrical container. In some embodiments, the anode terminal casing consists of a second material that is different from the first material, such as stainless steel.

In some embodiments, the second material comprises stainless steel. In some embodiments, the first material comprises less than about 0.5 wt. % iron, less than about 0.5 wt. % oxygen, less than about 0.5 wt. % carbon, less than about 0.5 wt. % nitrogen, and less than about 0.5 wt. % hydrogen, wherein a balance or substantially all of the balance of the composition is titanium. In some embodiments, the first material comprises about 0.3 wt. % iron, about 0.25 wt. % oxygen, about 0.1 wt. % carbon, about 0.03 wt. % nitrogen, and about 0.015 wt. % hydrogen, wherein a balance or substantially all of the balance of the composition is titanium.

In some embodiments, the first material has an ultimate tensile strength of between about 40,000 psi and about 60,000 psi. In some embodiments, the first material has a breaking elongation of between about 10% and about 50%. In some embodiments, the first material has an clastic modulus of between about 10,000 ksi and about 20,000 ksi. In some embodiments, the first material has a compressive modulus of between about 10,000 ksi and about 20,000 ksi. In some embodiments, the first material has a shear modulus of between about 4,000 ksi and about 10,000 ksi. In some embodiments, the first material has a Poisson's ratio of between about 0.25 and about 0.40. In some embodiments, the first material has an annealed fracture toughness of between about 50 ksi-in^{1/2} and about 65 ksi-in^{1/2}. In some embodiments, the first material has an electrical resistivity of between about 40μΩ·cm and about 100μΩ·cm.

According to another embodiment, a method for manufacturing or forming a casing for an electrochemical coin cell can be carried out. In some embodiments, the method can comprise: forming a first contact surface for the electrochemical coin cell from a first sheet consisting of a first material, the first material comprising greater than about 99 wt. % titanium; forming a cylindrical housing cup from a second sheet consisting of a second material, the cylindrical housing cup comprising a substantially flat bottom and a side wall formed circumferentially about the substantially flat bottom, the substantially flat bottom forming a second contact surface for the electrochemical coin cell, the substantially flat bottom and the side wall forming an inner volume; disposing active electrochemical components into the inner volume of the cylindrical housing cup, the active electrochemical components comprising an anode, a separator and a cathode, wherein the active electrochemical components are configured to produce an output open circuit voltage of at least 2.8 volts in the presence of a non-aqueous electrolyte; and sealing the active electrochemical components within the inner volume of the electrochemical coin cell by joining a circumferential edge of the first contact surface to one or more portions of the side wall of the cylindrical housing cup such that the first and second contact surfaces are in electrical communication with the active electrochemical components. In some embodiments, the circumferential edge of the first contact surface is joined to the one or more portions of the side wall of the cylindrical housing cup by bending or crimping one or more of the circumferential edge of the first contact surface or the one or more portions of the side wall of the cylindrical housing cup.

In some embodiments, the first contact surface consisting of the first material is dimensioned and configured to be resistant to reactions producing hydroxides during exposure to human bodily fluids. In some embodiments, the first material is different than the second material. In some embodiments, the second material comprises stainless steel. In some embodiments, the first material comprises less than about 0.5 wt. % iron, less than about 0.5 wt. % oxygen, less than about 0.5 wt. % carbon, less than about 0.5 wt. % nitrogen, and less than about 0.5 wt % hydrogen, wherein a balance or substantially all of the balance of the composition is titanium. In some embodiments, the first material comprises about 0.3 wt. % iron, about 0.25 wt. % oxygen, about 0.1 wt. % carbon, about 0.03 wt. % nitrogen, and about 0.015 wt. % hydrogen, wherein a balance or substantially all of the balance of the composition is titanium.

In some embodiments, the first material has an ultimate tensile strength of between about 40,000 psi and about 60,000 psi. In some embodiments, the first material has a breaking elongation of between about 10% and about 50%. In some embodiments, the first material has an clastic modulus of between about 10,000 ksi and about 20,000 ksi. In some embodiments, the first material has a compressive modulus of between about 10,000 ksi and about 20,000 ksi. In some embodiments, the first material has a shear modulus of between about 4,000 ksi and about 10,000 ksi. In some embodiments, the first material has a Poisson's ratio of between about 0.25 and about 0.40. In some embodiments, the first material has an annealed fracture toughness of between about 50 ksi-in^{1/2} and about 65 ksi-in^{1/2}. In some embodiments, the first material has an electrical resistivity of between about 40μΩ·cm and about 100μΩ·cm.

In some embodiments, the method can further comprise: coating a portion or all of the first material or the first contact surface with a nickel-containing surface coating.

Many modifications and other embodiments of the embodiments set forth herein will come to mind to one skilled in the art to which these embodiments pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

Unless otherwise indicated, all numbers expressing quantities of ingredients, reaction conditions, and so forth used in the specification and claims are to be understood as being modified in all instances by the term “about”. Accordingly, unless indicated to the contrary, the numerical parameters set forth in the present specification and attached claims are approximations that can vary depending upon the desired properties sought to be obtained by the present application. Generally the term “about”, as used herein when referring to a measurable value such as an amount of weight, time, dose, etc. is meant to encompass in one example variations of ±20%, in another example ±10%, in another example ±5%, in another example ±1%, and in yet another example ±0.1% from the specified amount, as such variations are appropriate to perform the disclosed method.

All examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any data flow sequence(s), program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features and steps are not limited to serial execution, but rather may be executed asynchronously, concurrently, in parallel, simultaneously, synchronously, and/or the like are also contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations that are disclosed and may not explicitly recited. As such, it should be understood that advantages, embodiments, examples, functional, features, logical, operational, organizational, structural, topological, and/or other aspects of the disclosure are not to be considered limitations on the disclosure as defined by the embodiments, examples, claims or limitations on equivalents to the embodiments, examples, and/or claims. It is to be understood that, depending on the particular needs and/or characteristics of an electrochemical cell, such as a coin cell battery or the like, various embodiments or portions of various embodiments of the coin cell batteries described herein may be implemented that allow a great deal of flexibility and customization. For example, aspects of the coin cell battery may be changed to allow for a greater voltage output, for a rechargeable coin cell battery, or for a different battery form factor or battery configuration having the same or a similar, mutatis mutandis, contact or terminal formed from a titanium-containing material such as those described herein, etc. While various embodiments and discussions of the titanium-containing terminal and methods for forming the same have been directed to coin cells and other electrochemical devices, however, it is to be understood that the embodiments described herein may be readily configured and/or customized for a wide variety of other applications and/or implementations, such as cylinder batteries, pouch batteries, and/or the like.

1. A casing for an electrochemical coin cell, the casing comprising:
a housing having a flat wall and a side wall extending from one or more edges of the flat wall of the housing to form a housing can; and
a planar conductive portion joined to the side wall of the housing to form an inner cavity configured to hold active components of the electrochemical coin cell, the planar conductive portion comprises greater than about 95 wt. % titanium,
wherein, in an instance in which a bend is formed in the planar conductive portion, the bend having a bend radius between about 100% and about 500% of a thickness of the planar conductive portion, the planar conductive portion is free or substantially free of cracking and microcracking.

2. The casing of claim 1, wherein the housing or the planar conductive portion comprises greater than about 99 wt. % titanium.

3. The casing of claim 2, wherein the housing or the planar conductive portion comprises less than about 0.5 wt. % iron, less than about 0.5 wt. % oxygen, less than about 0.5 wt. % carbon, less than about 0.5 wt. % nitrogen, and less than about 0.5 wt % hydrogen.

4. The casing of claim 3, wherein the housing or the planar conductive portion comprises about 0.3 wt. % iron, about 0.25 wt. % oxygen, less than or equal to about 0.08 wt. % carbon, about 0.03 wt. % nitrogen, and about 0.015 wt. % hydrogen.

5. The casing of claim 1, wherein the housing or the planar conductive portion has an ultimate tensile strength of between about 30,000 psi and about 60,000 psi.

6. The casing of claim 1, wherein the housing or the planar conductive portion has a breaking elongation of between about 20% and about 50%.

7. The casing of claim 1, wherein the housing or the planar conductive portion is a positive can that has an elongation of greater than about 20% at room temperature.

8. The casing of claim 1, wherein the housing or the planar conductive portion has an electrical resistivity of between about 40 μΩ·cm and about 100 μΩ·cm.

9. The casing of claim 1, wherein an exterior circumferential portion of the planar conductive portion is bent between about 60 degrees and about 160 degrees out of plane with a remainder of the planar conductive portion when being joined with the side wall of the housing.

10. The casing of claim 1, wherein one or more of the housing or the planar conductive portion comprises a surface portion comprising one or more of: TiN, Ti₂N, or TiC.

11. The casing of claim 8, wherein one or more of the housing or the planar conductive portion comprises a surface coating comprising nickel such that the electrical resistivity is reduced to less than about 50μΩ·cm.

12. The casing of claim 1, wherein the housing or the planar conductive portion comprises a material that is resistant to reactions that cause hydroxide formation.

13. The casing of claim 4, wherein the housing or the planar conductive portion further comprises one or more of: about 0.05 wt. % ruthenium, about 0.5 wt. % nickel, less than or equal to about 0.3 wt. % iron, less than or equal to about 0.10 wt. % oxygen, less than or equal to about 0.08 wt. % carbon, about less than or equal to 0.03 wt. % nitrogen, and less than or equal to about 0.015 wt. % hydrogen.

14. An electrochemical coin cell comprising:
a cylindrical casing comprising a negative contact surface and a side wall formed circumferentially about the negative contact surface, wherein the cylindrical casing defines an inner volume;
an anode material disposed within a first portion of the inner volume;
a cathode material disposed within a second portion of the inner volume;
a separator disposed within the inner volume between the anode material and the cathode material;
an electrolyte material disposed within the inner volume and configured to communicate ions between the anode material and the cathode material; and
a planar positive contact surface comprising a titanium-containing material, the planar positive contact surface being disposed within or adjacent to the inner volume such that the anode material, the cathode material, the separator, and the electrolyte material are enclosed within the inner volume, wherein a portion of the side wall is joined to an edge of the planar negative contact surface to seal the inner volume of the cylindrical casing,
wherein a thickness of the planar positive contact surface is between about 0.1 mm and about 0.5 mm, and
wherein a bend radius at the edge of the planar positive contact surface relative to the side wall of the cylindrical casing is equal to or less than about 200% of the thickness of the planar positive contact surface.

15. A method for manufacturing a casing for an electrochemical coin cell, the method comprising:
forming a first contact surface for the electrochemical coin cell from a first sheet consisting of a first material or cladded in the first material, the first material consisting of greater than about 99 wt. % titanium;
forming a cylindrical housing cup from a second sheet consisting of a second material, the cylindrical housing cup comprising a substantially flat bottom and a side wall formed circumferentially about the substantially flat bottom, the substantially flat bottom forming a second contact surface for the electrochemical coin cell, the substantially flat bottom and the side wall forming an inner volume;
disposing active electrochemical components into the inner volume of the cylindrical housing cup, the active electrochemical components comprising an anode, a separator, and a cathode, wherein the active electrochemical components are configured to produce an output open circuit voltage of at least 2.8 volts in the presence of a non-aqueous electrolyte; and
sealing the active electrochemical components within the inner volume of the electrochemical coin cell by joining a circumferential edge of the first contact surface to one or more portions of the side wall of the cylindrical housing cup such that the first and second contact surfaces are in electrical communication with the active electrochemical components, wherein the circumferential edge of the first contact surface is joined to the one or more portions of the side wall of the cylindrical housing cup by bending or crimping one or more of the circumferential edge of the first contact surface or the one or more portions of the side wall of the cylindrical housing cup.
